(19) United States
(12) Patent Application Publication
(10) Pub. No.: US 2024/0377928 A1
(43) Pub. Date: Nov. 14, 2024

(54) INTERACTION METHOD AND APPARATUS, ELECTRONIC DEVICE, AND STORAGE MEDIUM

(71) Applicant: Beijing Zitiao Network Technology Co., Ltd., Beijing (CN)

(72) Inventors: Liyue ZHAO, Beijing (CN); Bowen SHEN, Beijing (CN); Hongze LIU, Beijing (CN)

(21) Appl. No.: 18/574,621

(22) PCT Filed: Aug. 5, 2022
(86) PCT No.: PCT/CN2022/110649

§ 371 Date: Dec. 27, 2023

(30) Foreign Application Priority Data
Aug. 6, 2021 (CN) 202110904340.7

(51) Int. Cl. G06F 3/0484; G06F 3/0481; H04L 51/04

(52) U.S. Cl. CPC G06F 3/0484; G06F 3/0481; H04L 51/04

(57) ABSTRACT

An interaction method, an interaction apparatus, an electronic device, and a storage medium are provided. The interaction method includes: obtaining a change request for changing an association relationship between a first object collection and a second object collection; and changing the association relationship between the first object collection and the second object collection, so as to allow the second object collection to be no longer subordinate to the first object collection, or to allow the second object collection to be subordinate to the first object collection.

This application claims the priority to the Chinese Patent Application No. 202110904340.7, filed on Aug. 6, 2021, the entire disclosure of which is incorporated herein by reference as part of the disclosure of this application.

### TECHNICAL FIELD

Embodiments of the present disclosure relate to an interaction method, an interaction apparatus, an electronic device, and a storage medium.

### BACKGROUND

Internet communication technologies provide a variety of communication systems, such as online document communication, instant messaging (IM), etc. The IM provides a real-time communication system, which allows multiple users to use the network to transfer various types of data information in real time, such as text messages, voice messages, and files. Meanwhile, the IM may also support voice communication, video communication and the like between the multiple users in real time. At present, various communication system technologies, such as the instant messaging, have been widely applied in different scenarios or fields, such as the office, teaching, entertainment, etc. In particular, online office systems based on the Internet communication technologies are getting more attention, and these online office systems may manage such as company employees, clients, and the like in a variety of combination forms and implement information interaction.

### SUMMARY

At least one embodiment of the present disclosure provides an interaction method, and the interaction method includes: obtaining a change request for changing an association relationship between a first object collection and a second object collection; and changing the association relationship between the first object collection and the second object collection, so as to allow the second object collection to be no longer subordinate to the first object collection, or to allow the second object collection to be subordinate to the first object collection.

At least one embodiment of the present disclosure further provides an interaction method, and the interaction method includes: providing a first object collection, where the first object collection has at least one second object collection subordinate to the first object collection, member objects of the first object collection perform interaction in a form based on the at least one second object collection, the at least one second object collection comprises a default object collection, and the member objects of the first object collection are identical to member objects of the default object collection; and maintaining an association relationship between the first object collection and the default object collection during existence of the first object collection, so as to allow the member objects of the first object collection to remain identical to the member objects of the default object collection.

At least one embodiment of the present disclosure further provides an interaction apparatus, and the interaction apparatus includes a change request obtaining unit and a change unit; the change request obtaining unit is configured to obtain a change request for changing an association relationship between a first object collection and a second object collection; and the change unit is configured to change the association relationship between the first object collection and the second object collection, so as to allow the second object collection to be no longer subordinate to the first object collection, or to allow the second object collection to be subordinate to the first object collection.

At least one embodiment of the present disclosure further provides an interaction apparatus, and the interaction apparatus includes a first object collection providing unit and an association relationship maintaining unit; the first object collection providing unit is configured to provide a first object collection, where the first object collection has at least one second object collection subordinate to the first object collection, member objects of the first object collection perform interaction in a form based on the at least one second object collection, the at least one second object collection comprises a default object collection, and the member objects of the first object collection are identical to member objects of the default object collection; and the association relationship maintaining unit is configured to maintain an association relationship between the first object collection and the default object collection during existence of the first object collection, so as to allow the member objects of the first object collection to remain identical to the member objects of the default object collection.

At least one embodiment of the present disclosure further provides an electronic device, and the electronic device includes a processor and a memory; the memory includes one or more computer-executable instructions; the one or more computer-executable instructions are stored on the memory and configured to be executed by the processor; and the one or more computer-executable instructions are configured to implement the interaction method according to any one of the embodiments of the present disclosure.

At least one embodiment of the present disclosure further provides a storage medium, the storage medium is configured to store non-transitory computer-executable instructions, and the non-transitory computer-executable instructions, when executed by a processor, cause the processor to implement the interaction method according to any one of the embodiments of the present disclosure.

### BRIEF DESCRIPTION OF THE DRAWINGS

In order to clearly illustrate the technical solutions of the embodiments of the present disclosure, the drawings of the embodiments will be briefly described in the following. It is obvious that the described drawings are only related to some embodiments of the present disclosure and thus are not limitative to the present disclosure.

FIG. 1 shows a system that can be used to implement an interaction method provided by embodiments of the present disclosure;

FIG. 2 is a schematic flowchart of an interaction method provided by some embodiments of the present disclosure;

FIG. 3 is a schematic diagram of an application example based on a first object collection provided by some embodiments of the present disclosure;

FIG. 4 is a schematic diagram of another application example based on a first object collection provided by some embodiments of the present disclosure;

FIG. 5 is a schematic flowchart of a specific example of an interaction method provided by some embodiments of the present disclosure;

FIG. 6 is a schematic flowchart of another specific example of an interaction method provided by some embodiments of the present disclosure;

FIG. 7 is a schematic flowchart of further still another specific example of an interaction method provided by some embodiments of the present disclosure;

FIG. 8 is a schematic flowchart of further still another specific example of an interaction method provided by some embodiments of the present disclosure;

FIG. 9 is a schematic flowchart of further still another specific example of an interaction method provided by some embodiments of the present disclosure;

FIG. 10 is a schematic flowchart of further still another specific example of an interaction method provided by some embodiments of the present disclosure;

FIG. 11 is a schematic diagram of further still another application example based on a first object collection provided by some embodiments of the present disclosure;

FIG. 12 is another schematic flowchart of an interaction method provided by some embodiments of the present disclosure;

FIG. 13 is further still another schematic flowchart of an interaction method provided by some embodiments of the present disclosure;

FIG. 14 is further still another schematic flowchart of an interaction method provided by some embodiments of the present disclosure;

FIG. 15 is further still another schematic flowchart of an interaction method provided by some embodiments of the present disclosure;

FIG. 16 is further still another schematic flowchart of an interaction method provided by some embodiments of the present disclosure;

FIG. 17 is a schematic block diagram of an interaction apparatus provided by some embodiments of the present disclosure;

FIG. 18 is a schematic block diagram of an interaction apparatus provided by some embodiments of the present disclosure;

FIG. 19 is a schematic block diagram of an electronic device provided by some embodiments of the present disclosure;

FIG. 20 is another schematic block diagram of an electronic device provided by some embodiments of the present disclosure; and

FIG. 21 is a schematic diagram of a storage medium provided by some embodiments of the present disclosure.

### DETAILED DESCRIPTION

The embodiments of the present disclosure will be described in more detail below with reference to the accompanying drawings. While certain embodiments of the present disclosure are shown in the drawings, it should be understood that the present disclosure may be embodied in various forms and should not be construed as limited to the embodiments set forth herein. Rather, these embodiments are provided for a thorough and complete understanding of the present disclosure. It should be understood that the drawings and embodiments of the present disclosure are only for exemplary purposes and are not intended to limit the protection scope of the present disclosure.

It should be understood that the various steps described in the method implementations of the present disclosure may be performed in different orders and/or in parallel. Furthermore, the method implementations may include additional steps and/or omit performing the illustrated steps. The scope of the present disclosure is not limited in this aspect.

As used herein, the terms “include,” “comprise,” and variations thereof are open-ended inclusions, i.e., “including but not limited to.” The term “based on” is “based, at least in part, on.” The term “an embodiment” represents “at least one embodiment,” the term “another embodiment” represents “at least one additional embodiment,” and the term “some embodiments” represents “at least some embodiments.” Relevant definitions of other terms will be given in the description below.

It should be noted that concepts such as the “first,” “second,” or the like mentioned in the present disclosure are only used to distinguish different devices, modules or units, and are not used to limit the interdependence relationship or the order of functions performed by these devices, modules or units.

It should be noted that the modifications of “a,” “an,” “a plurality of,” and the like mentioned in the present disclosure are illustrative rather than restrictive, and those skilled in the art should understand that unless the context clearly indicates otherwise, these modifications should be understood as “one or more.”

The names of messages or information exchanged between multiple devices in the embodiments of the present disclosure are only for illustrative purposes, and are not intended to limit the scope of these messages or information.

Taking an instant messaging system as an example, the limitations of the current Internet communication technologies are illustratively analyzed as: when a user performs information interaction using the instant messaging technology, for example, if the user sends, such as a text or voice message through the instant messaging software, the user may send the message to a specific user individually, or the user may also join a group and perform information interaction with other members in the group. However, when the user joins a group, the text or voice messages sent by the user in the group are visible to all the members of the group, and for example, the user cannot choose to communicate or share information with only some members of the group according to different actual needs. Moreover, when the user sends different types of information, such as work, study, entertainment, or the like, the different types of information will all be displayed in the same group, which may cause complicated and fragmented message interaction within the group. Thus, it is difficult for group users to quickly and efficiently acquire the required information according to the specific needs for different types of information, resulting in that the user tends to miss some important information or needs to spend a lot of time browsing through the information in the group. Furthermore, once the group is suddenly disbanded, the user is unable to access historical information in the group, which may cause easy loss and omission of data information.

At least one embodiment of the present disclosure provides an interaction method, and the interaction method includes: obtaining a change request for changing an association relationship between a first object collection and a second object collection; and changing the association relationship between the first object collection and the second object collection, so as to allow the second object collection to be no longer subordinate to the first object collection and to allow the second object collection to have more independent operational permissions relative to the first object collection after the changing than before the changing, or to allow the second object collection to be subordinate to the first object collection and to allow at least part of information interaction within the second object collection to be controlled by the first object collection.

For example, the first object collection and the second object collection each may refer to a collection that includes multiple member objects; alternatively, the first object collection and the second object collection each may refer to a data entity or data object that organizes multiple member objects to implement specific functions or operations; alternatively, the first object collection and the second object collection each may also refer to a data entity or data object that organizes multiple member objects to provide specific functions to the multiple member objects, or to allow the multiple member objects to perform specific operations.

For example, the first object collection or the second object collection may organize member objects, so that the member objects may realize data or information interaction in the first object collection or the second object collection, or provide services such as data or information interaction in the first object collection or the second object collection. For example, member objects may perform data or information interaction directly in the form based on the first object collection or the second object collection, or may provide services such as data or information interaction functions directly in the form based on the first object collection or the second object collection. For example, the first object collection or the second object collection itself may be a group chat or a discussion group including multiple users.

For another example, the first object collection may be provided with interaction methods such as a platform or channel for member objects to perform data or information interaction, so that the member objects of the first object collection are allowed to implement data or information interaction under the overall organizational structure of the first object collection. For example, the member objects of the first object collection are allowed to perform data or information interaction through the second object collection subordinate to the first object collection, so that the first object collection can indirectly have an effect or function of providing information interaction. For example, the first object collection itself may be a contact group including multiple users, and a group chat, a discussion group, or the like is provided in the first object collection, so as to enable the users to perform information interaction through the group chat, the discussion group, etc.

The interaction method provided by the above embodiments of the present disclosure can flexibly change an association relationship between the first object collection and the second object collection, and also reduce or avoid possible adverse effects on the data or functions such as information interaction in the first object collection and the second object collection during changing of the association relationship.

At least one embodiment of the present disclosure further provides an interaction method, and the interaction method includes: providing a first object collection, where the first object collection has at least one second object collection subordinate to the first object collection, member objects of the first object collection perform interaction in a form based on the at least one second object collection, the at least one second object collection includes a default object collection, and the member objects of the first object collection are identical to member objects of the default object collection; and maintaining an association relationship between the first object collection and the default object collection during existence of the first object collection, so as to allow the member objects of the first object collection to remain identical to the member objects of the default object collection.

In the interaction method provided by the above embodiments of the present disclosure, a default object collection is provided in the second object collection that is subordinate to the first object collection, and the member objects of the first object collection remain the same as the member objects of the default object collection, so that it can be ensured that all the member objects of the first object collection can implement interaction through the default object collection, and further, in the case of the first object collection having a plurality of second object collections subordinate to the first object collection, some or all of the member objects of the first object collection can implement different forms or types of information interaction through the plurality of second object collections.

In the following, the embodiments of the present disclosure will be described in detail with reference to the accompanying drawings. It should be noted that the same reference signs in different figures will be used to refer to the same elements that have been described.

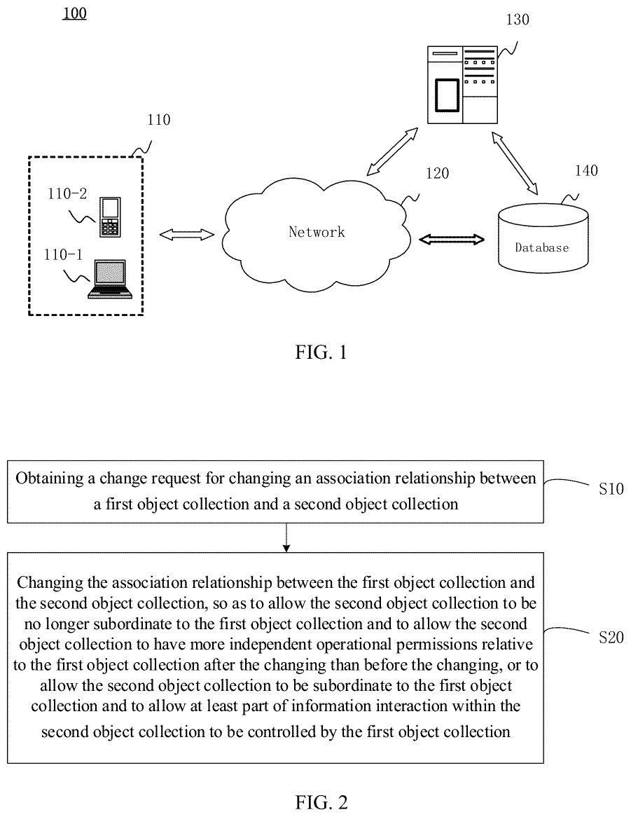

FIG. 1 shows a system that can be used to implement an interaction method provided by embodiments of the present disclosure. As illustrated in FIG. 1, a system 100 may include a user terminal 110, a network 120, a server 130, and a database 140. For example, the system 100 may be configured to implement an interaction method according to any one of the embodiments of the present disclosure.

The user terminal 110 is, for example, a computer 110-1 or a cell phone 110-2. It should be understood that the user terminal 110 may be any other type of electronic devices capable of executing data processing, which may include, but is not limited to, a desktop computer, a laptop computer, a tablet computer, a smartphone, a smart home device, a wearable device, an in-vehicle electronic device, a monitoring device, and the like. The user terminal 110 may also be any equipment provided with an electronic device, such as a vehicle, a robot, etc.

A user may operate through an application installed on the user terminal 110. The application transmits user behavior data to the server 130 through the network 120. The user terminal 110 may also receive data transmitted by the server 130 through the network 120.

For example, the application on the user terminal 110 may be a social application, and the social application may refer to an application that sends and receives messages or performs instant messaging based on a social relation chain between users. In the social application, the user may send a message to a contact or receive a message from a contact. The contact may be a single user or a group. For example, the group is a cluster containing at least two users, and the group may also be referred to as a contact group, a group chat, a discussion group, or the like.

The user terminal 110 may implement the interaction method provided by the embodiments of the present disclosure by running programs or threads. In some examples, the user terminal 110 may utilize its built-in application to perform the interaction method. In some other examples, the user terminal 110 may perform the interaction method by invoking applications stored externally to the user terminal 110.

The network 120 may be a single network, or a combination of at least two different networks. For example, the network 120 may include, but is not limited to, a combination of one or more of a local area network, a wide area network, a public network, a private network, and the like.

The server 130 may be an individual server, or a cluster of servers. Individual servers within the cluster of servers are connected via a wired or wireless network. A cluster of servers may be centralized, for example, a data center, or may be distributed. The server 130 may be local or remote. The server 130 may communicate with the user terminal 110 via a wired or wireless network.

The database 140 may refer generically to a device having a storage function. The database 140 is primarily configured to store various data utilized, generated, and outputted by the user terminal 110 and the server 130 in operation. The database 140 may be local or remote. The database 140 may include various memories, such as a random access memory (RAM), a read only memory (ROM), and the like. The storage devices mentioned above are only examples, and the storage devices that can be used by the system 100 are not limited to the above.

The database 140 may be interconnected or in communication with the server 130 or a part of the server 130 via the network 120, or directly interconnected or in communication with the server 130, or via a combination of the above.

In some examples, the database 140 may be a standalone device. In some other examples, the database 140 may also be integrated in at least one of the user terminal 110 or the server 130. For example, the database 140 may be provided on the user terminal 110 or may be provided on the server 130. For another example, the database 140 may also be distributed, with a part provided on the user terminal 110 and another part provided on the server 130.

FIG. 2 is a schematic flowchart of an interaction method provided by some embodiments of the present disclosure. The interaction method may be applied on the server 130 in the system 100 shown in FIG. 1. For example, a person user may access the server via the user terminal 110 and perform operations through an operation interface provided by client software on the user terminal 110, e.g., in a social application applied on the user terminal 110.

As shown in FIG. 2, the interaction method provided by the embodiments of the present disclosure includes steps S10 and S20.

Step S10: obtaining a change request for changing an association relationship between a first object collection and a second object collection.

Step S20: changing the association relationship between the first object collection and the second object collection, so as to allow the second object collection to be no longer subordinate to the first object collection and to allow the second object collection to have more independent operational permissions relative to the first object collection after the changing than before the changing, or to allow the second object collection to be subordinate to the first object collection and to allow at least part of information interaction within the second object collection to be controlled by the first object collection.

For example, for the above Step S10, the first object collection and the second object collection may each be a collection including one or more member objects. For example, the one or more member objects may be various types of member objects having different attributes, different functions, or being used for different operations and belonging to the corresponding object collections.

For example, the types of the member objects of the first object collection and the types of the member objects of the second object collection may be the same as each other or may be different from each other.

For example, the member objects of the first object collection may be a user, or may be a group of users including multiple users, or may be controls configured to serve the users, for example, functional controls such as collaborative documents, calendars, and teleconferences, or containerized controls configured to store relevant interaction information, and the like. For example, a control refers to an encapsulation of data and methods, so that a user is enabled to perform an operation by the control, or a specific function is provided to a user via the control. As an example, the interaction method provided by the embodiments of the present disclosure is applied to the social application, and the user may refer to a real person or entity that uses the relevant device or network service, i.e., a real user; alternatively, the user may refer to a computer program set up in a system which is capable of simulating a human conversation for the purpose of providing a service, such as a chatbot or a service assistant. For example, a set of users may refer to a cluster, for example, a group of users, containing at least two users.

For example, the member objects of the first object collection may be of the same or different object types. For example, the member objects in the first object collection each may be a real person or entity that uses the relevant device or network service, or the member objects in the first object collection may include both a real user and a computer program that provides a service, such as a chatbot or a service assistant. For example, in the first object collection, there may be a member object in the form of a user, and there may also be a member object in the form of a set of users (e.g., a group of users including multiple users).

For example, the member object of the second object collection may be a user, or may be a group of users including multiple users, or may be a control configured to serve the users, for example, functional controls such as collaborative documents, calendars, and teleconferences, or containerized controls configured to store relevant interaction information, and the like. For example, the control may serve the users to enable the users to perform different interaction operations through the control or to provide the users with different interaction functions, information storage functions, and the like. The types of member objects in the second object collection may be the same as or different from each other, that is, the second object collection may have a member object in the form of a user, and may also have a functional or containerized control as a member object, such as the collaborative document, calendar, teleconference, etc.

The embodiments of the present disclosure do not impose specific limitations on the types, attributes, functions, or the like of the member objects of the first object collection and the member objects of the second object collection.

For example, the first object collection organizes the member objects, so that the member objects may realize data or information interaction in the first object collection. For example, the member objects may directly perform data or information interaction in the form based on the first object collection, and the first object collection itself may be a group chat or a discussion group containing multiple users, etc.; alternatively, other forms of interaction, such as a platform or a channel for the member objects to perform data or information interaction, may be provided in the first object collection, so as to enable the member objects to realize data or information interaction under the overall organizational structure of the first object collection. For example, the first object collection itself may be a contact group containing multiple users, and such as a group chat or a discussion group is provided in the first object collection, so as to enable the users to perform information interaction through the group chat, the discussion group, etc.

For example, the second object collection may be a platform or channel that serves a user and is used to provide such as a platform or a channel that enables data or information interaction to be implemented between the member objects of the second object collection, so that the member objects of the second object collection may directly perform data or information interaction in the form based on the second object collection. For example, the second object collection may be a chat group having multiple users as multiple member objects respectively, so that the multiple users may perform interactions of information in the chat group, such as interactions of text, images, voice, video, or web links.

For example, the second object collection may also be a collection having functional controls as member objects, such as documents, calendars, and teleconferences, or having containerized controls for interaction information storage as member objects, so as to provide an information interaction mode based on the functional controls, such as documents, calendars, and teleconferences, or to provide an interaction information storage function. For example, in the case that the second object collection is subordinate to the first object collection, the member objects of the first object collection may access the member objects of the second object collection (e.g., documents, calendars, or teleconferences) and process the member objects by corresponding operations, so that the member objects in the first object collection can realize interaction of different types of information or operations in the form based on the second object collection.

The embodiments of the present disclosure do not impose specific limitations on the specific forms, functions, or types of the first object collection and the second object collection.

For example, in the embodiments of the present disclosure, for Step S20, the second object collection being “subordinate” to the first object collection may represent that operational permissions that the second object collection can execute are restricted to operational permissions that the first object collection can execute. Alternatively, it may also represent that an information transmission boundary or transmission range of the second object collection is restricted to an information transmission boundary or transmission range of the first object collection.

For example, for the above Step S20, the change request in the above Step S10 may be a request for removing the association relationship between the first object collection and the second object collection according to different actual needs. After the association relationship between the first object collection and the second object collection is removed in response to the change request, the second object collection is no longer subordinate to the first object collection, some or all of the operational permissions of the second object collection may be independent of the first object collection, and some or all of the operations of the second object collection are allowed to be controlled independently of the first object collection. That is, the independent operational permissions of the second object collection with respect to the first object collection before the change are less than the independent operational permissions of the second object collection with respect to the first object collection after the change. Thus, since at least some of the operational permissions of the second object collection no longer belong to the first object collection, that is, since implementation of at least part of the operations of the second object collection is no longer dependent on the first object collection, it is possible to attenuate or avoid that specific operations or functions or the like under the first object collection and the second object collection are adversely affected after the association relationship between the first object collection and the second object collection is removed. For example, it is possible to avoid unnecessary loss of data or functional failure of the first object collection or the second object collection.

For example, for the above Step S20, the change request in the above Step S10 may also be a request for establishing the association relationship between the first object collection and the second object collection according to different actual needs. After the association relationship between the first object collection and the second object collection is established in response to the change request, the second object collection is subordinate to the first object collection, and some or all of the operational permissions of the second object collection belong to the first object collection. That is, the independent operational permissions of the second object collection with respect to the first object collection after the change are less than the independent operational permissions of the second object collection with respect to the first object collection before the change, so as to allow the first object collection to control some or all of the operations of the second object collection, so that some or all of the operations of the second object collection are changed into subordinate operations dependent on the first object collection. For example, some or all of the operations of the second object collection are implemented by interacting with the first object collection, that is, one, some, or all of the operations of the first object collection correspond to the some or all of the above operations of the second object collection, so as to achieve interaction. Thus, not only can it help the member objects of the first object collection to access the second object collection, so that the member objects of the first object collection can quickly and efficiently acquire the data or information in the second object collection, for example, to realize information interaction in the form based on the second object collection, but it can also simplify the operation control process of the second object collection by handing over some of the operational permissions of the second object collection to the first object collection, and further avoid possible operational conflicts between the first object collection and the second object collection, thereby optimizing the overall operation process.

Thus, the abovementioned interaction method according to the embodiments of the present disclosure may not only realize a flexible change of the association relationship between the first object collection and the second object collection, but also reduce or avoid possible adverse effects on the data or functions such as information interaction within the first object collection and the second object collection during changing of the association relationship.

In some embodiments of the present disclosure, in the case that the second object collection is subordinate to the first object collection, each member object of the first object collection has operational permissions on the second object collection or each member object of the second object collection, such as accessing data, invoking data, modifying data, or performing other processing operations.

Alternatively, in some embodiments of the present disclosure, in the case that the second object collection is subordinate to the first object collection, the second object collection is a sub-collection of the first object collection, that is, any one of the member objects of the second object collection is a member object of the first object collection, and the member objects of the first object collection include the member objects of the second object collection. For example, the member objects of the first object collection may include member objects other than some of the member objects that are the same as the member objects of the second object collection; alternatively, the member objects of the first object collection may be the same as the member objects of the second object collection. Moreover, some or all of the operations on the member objects of the second object collection depend on operations on the member objects of the first object collection. For example, the second object collection may be set up in such a way that the second object collection does not have permissions to directly perform some or all of the operations on the member objects of the second object collection. For example, if the second object collection does not have the permissions to directly perform a change operation on the member objects of the second object collection, when it is necessary to change attributes, quantities, or other characteristic information of the member objects of the second object collection, the characteristic information of the member objects in the first object collection that are the same as the member objects of the second object collection are required to be changed, and the change operation is synchronized to the second object collection by such as synchronous data updating, thereby realizing the change to the member objects of the second object collection.

For example, in some embodiments of the present disclosure, the Step S10 may include: determining, in response to receiving a change triggering operation input by a user, that the change request for changing the association relationship between the first object collection and the second object collection is obtained. Thus, the association relationship between the various types of object collections for information interaction can be flexibly changed according to the actual needs of the user.

Hereinafter, in order to clearly illustrate the technical solutions of the present disclosure, in some embodiments of the present disclosure, steps in the interaction method according to the embodiments of the present disclosure are specifically described in an example where member objects of the first object collection are users and the first object collection is a first user collection containing multiple users, and where member objects of the second object collection are users and the second object collection is a second user collection containing multiple users. It should be noted that the interaction method provided by the present disclosure includes, but is not limited to, this regard.

For example, “member objects of the first object collection” referred to hereinafter may be understood as users of the first object collection, i.e., “the first user collection” or “users of the first user collection,” and “member objects of the second object collection” may be understood as users of the second object collection, i.e., “the second user collection” or “users of the second user collection.”

For example, in some examples, the “first object collection” may be represented or understood as a “team” or “organization” that contains multiple users, and the “second object collection” may be represented or understood as a “cluster” or “group” containing multiple users, e.g., a chat group for instant messaging for multiple users to perform interaction of information such as text, images, voice, video, and web links in the group.

For example, in an exemplary application scenario of an online office software, the “first object collection,” i.e., a “team,” is created, which includes all employees of a company, and one or more “second object collections,” i.e., “groups” are created to correspond to different types of subgroups in the company, for example, a “company chat group” created by the general manager's office, which includes all the employees of the company (e.g., corresponding to a default communication group of the company), for another example, a “human resource group” created by the human resource department that includes all the company employees, or for another example, a “marketing group” created by the marketing department that includes only members of the marketing department, a “technology group” created by the technology department that includes only members of the technology department, and the like. These groups are subordinate to the company which is as a team, and in these groups, the respective members can chat, share information, and the like. Thus, when an employee leaves the company, the employee will be removed from each group that the employee belongs to, or when a new employee joins the marketing department, the employee will be added to the “company chat group” and the “human resource group” which both contain all the employees of the company, and the employee will also be added to the “marketing group,” but not to the “technology group” or the like. However, non-employees of the company cannot be added to the company “team” and also cannot be added to any one of the groups of the company. Therefore, the company “team” defines boundaries of the information interaction of the groups subordinate to the company, and may, for example, further define permission boundaries of the groups subordinate to the company.

For example, when the abovementioned “team” is disbanded, each of the abovementioned groups may still exist, and members of the group may continue to have access to all or part of the information in the group, or perform information interaction through the group. For example, information that may be retained in the group for access may be set at the time of disbandment. For example, when the company goes out of business and disbands all of its employees, each of the abovementioned groups such as the “company chat group,” the “human resource group,” the “marketing group,” and the “technology group” may still exist, and each of the above groups may be disbanded at the discretion of group administrators. For example, if the “team” is disbanded and each of the above groups is separated from the “team,” then an administrator of each group may decide on his/her own whether to keep the group or disband the group, and the permission boundary of the retained group is no longer limited to the boundary of the “team.” For example, it is no longer limited to “company employees,” and new members may be added to the group or existing members may be removed.

In another exemplary application scenario of the online office software, a plurality of “first object collections,” i.e., “teams,” are created within the technology department, including a “product-1 team” that contains all the employees who develop the product 1, a “product-2 team” that contains all the employees who develop the product 2, and the like. For each team, it is also possible to create one or more subordinate “second object collections,” i.e., “groups,” corresponding to different tasks of product development. For example, for the “product-1 team,” it is possible to create a “daily communication group” (e.g., corresponding to a default communication group of the team) that contains all the employees who develop the product 1, a “module-1 communication group” that contains employees who develop the module 1, a “module-2 communication group” that contains employees who develop the module 2, and the like. An employee of the technology department may belong to one or more teams in the corresponding online office software, and may belong to one or more groups within a specific team. In a user interface of the online office software used by the employee, the one or more teams and one or more groups under each team may be listed at the same time, and the corresponding information exchange and sharing may be carried out in these groups. As different employees may belong to different teams or different groups within a specific team, different employees will have different user interfaces when using the online office software.

For example, each team has one or more team administrators. The team administrator is one of members of the team and has various permissions to manage the team, including adding or removing team members, disbanding the team, and creating one or more groups in the team. For example, the team administrator may also have a permission to disband the group in the team, or may have a permission to set up for some team member. The status of team administrator is transferable, i.e., may be transferred to other team members in the team. For example, team members can personalize the team they belong to, for example, by sticking a team that they belong to on the top, setting a do-not-disturb function, or the like.

For example, each group may have one or more group administrators, who are members of the group and have various permissions to manage the group, but the permissions to manage the group may vary in different application scenarios or according to requirements. For example, in the case that group members need to be the same as team members in the team to which they belong (e.g., in the case that the group members and the team members are bound), the group administrator does not have a permission to add or remove the group member. The status of group administrator is transferable, i.e., to other group members in the group. For example, group members may be set to have different permissions for the group they belong to, such as the permissions to listen to messages, send messages, send web links, initiate online meetings, share schedules, and the like. In addition, each group member may make various personalized settings, such as sticking the group they belong to on the top (e.g., sticking a group within a team on the top), setting a do-not-disturb function, and the like.

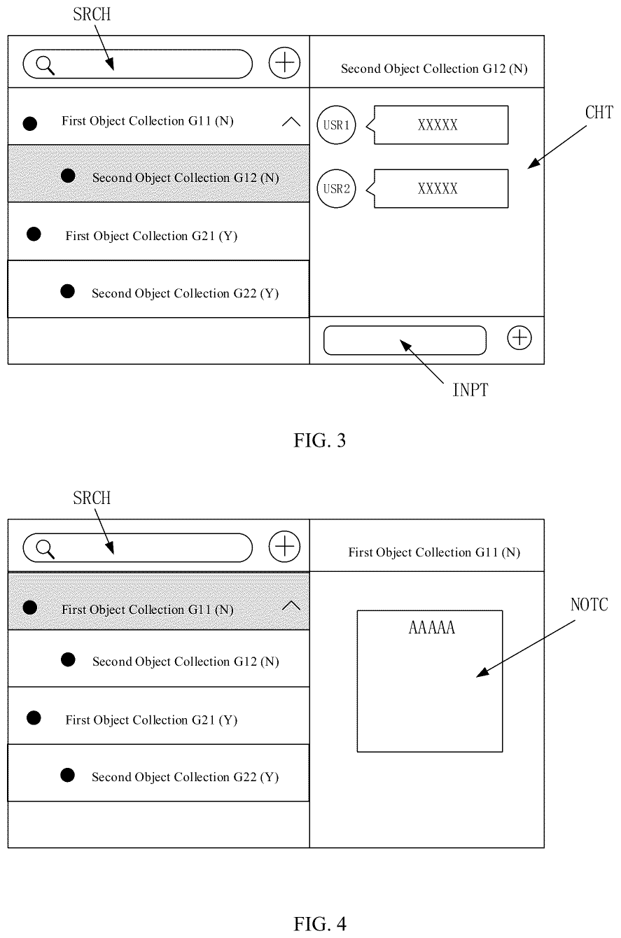

FIG. 3 is a schematic diagram of an application example based on a first object collection provided by some embodiments of the present disclosure.

For example, as illustrated in FIG. 3, a second object collection G12 being subordinate to a first object collection G11 may be presented in a visualization manner. The second object collection G12 is subordinate to the first object collection G11, and the second object collection G12 is displayed as being located below the first object collection G11 and indented to the right. The second object collection G22 is subordinate to the first object collection G21, and the second object collection G22 is displayed as being located below the first object collection G21 and indented to the right. For example, the second object collection G12 and the second object collection G22 may be chat groups for instant messaging. For example, as shown in FIG. 3, when a user selects the second object collection G12 by, for example, clicking on it in an operation interface, some or all of the members may be listed on the right page of the window, and a sub-window for chatting and information sharing, such as a chat interface CHT, is provided, so that N (e.g., N is a positive integer greater than one) member objects in the second object collection G12 can perform interaction of information, such as text, pictures, voice, and video, in the second object collection G12, and each member object of the second object collection G12 performs information interaction in the chat group, for example, by sending information such as text, pictures, voice, video and web links within the chat interface CHT of the chat group, or for another example, initiating an online meeting.

For example, taking the abovementioned application scenario of the online office software as an example, the first object collection G11 may be a “product-1 team” that contains all employees who develop the product 1, and the second object collection G12 may be a “daily communication group” created under the “product-1 team” that contains all employees who develop the product 1; and the first object collection G21 may be a “product-2 team” that contains all employees who develop the product 2, and the second object collection G22 may be a “daily communication group” created under the “product-2 team” that contains all employees who develop the product 2.

For example, FIG. 3 shows a user interface of the online office software used by a user through a client terminal that is allowed on a user terminal, that is, the user belongs to both the “product-1 team” and the “product-2 team.” For example, the client terminal does not display information (e.g., lists) for teams to which the user does not belong. For example, the user interface shown in FIG. 3 displays information related to the team and groups subordinate to the team via a tab, and the user may use this tab to operate in a team scenario; on the other hand, the user may also belong to a standalone group that is not subordinate to any team, the client terminal may display the standalone group in another tab, and the user may use this tab to operate in a standalone group scenario.

For example, in the case that the user belongs to a plurality of teams, the user may enter the name of a joined team (e.g., “product-1 team” or “product-2 team”) or part information of the name (e.g. “product 1” or “product 2”) into a team search box SRCH on the top of the left side of the window as shown in FIG. 3, so as to locate the team in the display interface. For example, the user may also click on an icon “ [symbol] ” on the right side of the team search box SRCH and perform an operation, for example, finding a team the user has not yet joined on a displayed sub-interface.

For example, as shown in FIG. 3, in a sub-window on the right, the chat interface CHT is used to display messages sent by various member objects in the second object collection G12 (e.g., messages sent by USR1 and USR2), and the user may perform information interaction with other member objects in the second object collection G12 by entering a text message that the user wishes to send into an information input box INPT located at the bottom of the sub-window. The user may also click on an icon “ [symbol] ” on the right side of the information input box INPT and select to send other types of information in the displayed sub-interface, such as pictures, audio, video, and web links in addition to the text.

In at least one example, as shown in FIG. 4, when a user selects the first object collection G11 by, for example, clicking on it in an operation interface, a sub-window for chatting and information sharing will not be provided on the right page of the window, and thus chatting and information sharing cannot be performed at the level of the first object collection G11. For example, when the user selects the first object collection G11 by, for example, clicking on it in the operation interface, a sub-window for displaying, for example, a team announcement or a team notification NOTC is provided on the right page of the window.

For example, the above information interaction in the second object collection G12 may include any of the following operations for a specific or non-specific member object: sending or receiving a text message; sending or receiving a voice message; sending or receiving a video message; sending or receiving a picture message; or sending or receiving a web link message, and the like. The network link information may, for example, be a connection for various appropriate network resources, such as the web page, audio, video, executable codes. The executable codes may, for example, be an applet, or a script (e.g., JavaScript.) for implementing a function such as “red packets.” It should be noted that the information interaction that can be implemented in the form based on the second object collection G2 includes, but is not limited to, the cases described above, and the embodiments of the present disclosure do not impose any specific limitations on the types, modes, or the like of the information interaction that can be implemented by the second object collection G2. For example, the operation may send a message that may be attended by all the member objects, or the operation may send a message that may be requested to be attended by a specific object (e.g., by means of “@User USR1” to remind the user USR1 to attend to the corresponding message).

For example, in the examples shown in FIG. 3 and FIG. 4, in the case that the second object collection G12 is subordinate to the first object collection G11, the first object collection G11 contains N member objects that are the same as the N member objects of the second object collection G12. In other words, N users represented by the N member objects in the first object collection G11 and N users represented by the N member objects in the second object collection G12 are the same set of users, for example, all the employees who develop the product 1. In the case that the second object collection G22 is subordinate to the first object collection G21, the first object collection G21 contains Y (e.g., Y is a positive integer greater than one) member objects which are the same as Y member objects of the second object collection G22. In other words, Y users represented by the Y member objects of the first object collection G21 and Y users represented by the Y member objects of the second object collection G22 are the same set of users, for example, all the employees who develop the product 2.

It should be noted that, the examples shown in FIG. 3 and FIG. 4 are illustrative, when the member objects of the first object collection G11 remain the same as the member objects in the second object collection G12, or when an increase or decrease of the member objects in the first object collection G11 affects an increase or decrease of the member objects in the second object collection G12, or when an increase or decrease of the member objects in the second object collection G12 affects an increase or decrease of the member objects in the first object collection G11, the member objects may be users, and accordingly the N member objects in the first object collection G11 and the N member objects in the second object collection G12 may both represent the same set of users.

Alternatively, in some other embodiments, it is possible that the N member objects of the first object collection G11 are users, and the N member objects of the second object collection G12 are, for example, controls, that is, the N members of the second object collection G12 are not users. In this case, the above “N” is only used to indicate the number of member objects.

It should be noted that in some other examples of the present disclosure, taking the first object collection G11 and the second object collection G12 as an example, in the case that the second object collection G12 is subordinate to the first object collection G11, the first object collection G11 may also contain member objects other than the N member objects, that is, the second object collection G12 is a sub-collection of the first object collection G11 and the member objects of the second object collection G12 are not all the same as the member objects of the first object collection G11. The examples shown in FIG. 3 and FIG. 4 are illustrated in the case that the second object collection G12 is subordinate to the first object collection G11, where the member objects of the second object collection G12 remain the same as the member objects of the first object collection G11, and for example, the member objects which remain the same are users. For example, the first object collection G11 is the “product-1 team” and the second object collection G12 is the “daily communication group” that contains all the employees who develop the product 1. The embodiments of the present disclosure include, but are not limited to, this regard.

For example, in the examples shown in FIG. 3 and FIG. 4, in the case that a change operation such as an adding or removing operation on the N member objects in the second object collection G12 is dependent on the operation on the N member objects in the first object collection G11, an adding operation may be performed on the member objects in the second object collection G12 correspondingly by performing an adding operation on the member objects of the first object collection G11. That is, when a member object is added to the first object collection G11, the same member object is added to the second object collection G12 correspondingly. Alternatively, a removing operation may be performed on the member objects in the second object collection G12 correspondingly by performing a removing operation on the member objects in the first object collection G11. That is, when a specific member object is removed from the first object collection G11, the member object in the second object collection G12 is removed correspondingly. The member object mentioned above may be a user.

For example, taking the abovementioned application scenario of the online office software as an example, when a new employee participates in the development of the product 1, the employee (i.e., the user) is added to the “product-1 team,” and accordingly, is also added to the “daily communication group” under the “product-1 team.” When an employee quits or is no longer involved in the development of the product 1, the employee is removed from the “product-1 team,” and accordingly, is removed from the “daily communication group” under the “product-1 team.”

Thus, in the case that the second object collection G12 is subordinate to the first object collection G11 and the member objects of the second object collection G12 remain the same as the member objects of the first object collection G11, by, for example, handing over an operational permission to change the member objects of the second object collection G12 to the first object collection G11, the operation of making a change to the member objects of the second object collection G12 can be simplified, and operational conflicts that may arise when making a change to the member objects of the first object collection G11 and the second object collection G12 can also be avoided, thereby optimizing the overall operation process.

For example, the second object collection G12 is set such that the adding or removing operation cannot be directly performed on the member objects of the second object collection G12. That is, the second object collection G12 is set such that there is no permission to directly perform a change operation on the member objects of the second object collection G12. Thus, possible operational conflicts between the first object collection G11and the second object collection G12 can be further reduced or avoided. For example, the member object mentioned above may be a user.

For example, taking the abovementioned application scenario of the online office software as an example, the “daily communication group” under the “product-1 team” cannot directly perform the adding or removing operation on users in the group, for example, the group administrator of the “daily communication group” does not have the permission to add or delete group members, and only the team administrator of the “product-1 team” can add or delete team members of the “product-1 team” to realize the addition or deletion of the group members of the “daily communication group.”

It should be noted that in the examples of FIG. 3 and FIG. 4, only one second object collection G12 subordinate to the first object collection G11 and one second object collection G22 subordinate to the first object collection G21 are shown, and the embodiments of the present disclosure do not limit the number of the second object collections G12 subordinate to the first object collection G11 or the number of the second object collections G22 subordinate to the first object collection G21. For example, when the first object collection G11 is the “product-1 team” that contains all the employees who develop the product 1, there may be a plurality of second object collections G12 subordinate to the first object collection G11, such as the “daily communication group” that contains all the employees who develop the product 1, the “module-1 communication group” that contains employees who develop the module 1 of the product 1, the “module-2 communication group” that contains employees who develop the module 2 of the product 1, and the like. For example, when the first object collection G21 is the “product-2 team” that contains all the employees who develop the product 2, there may be a plurality of second object collections G22 subordinate to the first object collection G21, such as the “daily communication group” that contains all the employees who develop the product 2, the “module-1 communication group” that contains employees who develop the module 1 of the product 2, the “module-2 communication group” that contains employees who develop the module 2 of the product 2, and the like.

For example, in some other embodiments of the present disclosure, in the case that the second object collection is subordinate to the first object collection and the member objects of the second object collection remain the same as the member objects of the first object collection, an adding operation may be performed on the member objects of the first object collection correspondingly by performing an adding operation on the member objects of the second object collection. That is, when a member object is added to the second object collection, the same member object is added to the first object collection correspondingly. Alternatively, a removing operation may be performed on the member objects of the first object collection correspondingly by performing a removing operation on the member objects of the second object collection. That is, when a member object is removed from the second object collection, the member object in the first object collection is removed correspondingly. For example, in such an operation process, the first object collection may be set such that no adding operation or removing operation can be directly performed on the member objects of the first object collection. For example, the member object mentioned above may be a user.

For example, in some other embodiments of the present disclosure, in the case that the second object collection is subordinate to the first object collection, the second object collection is a sub-collection of the first object collection, and the member objects of the second object collection are different from the member objects of the first object collection. For example, in order to change the number of the member objects of the first object collection and the second object collection, due to the fact that the second object collection is a sub-collection of the first object collection, when a specific member object is removed from the first object collection, which is also a member object of the second object collection, the member object in the second object collection is removed correspondingly; and when a specific member object is added to the first object collection, the second object collection determines whether or not it is necessary to add the member object according to the actual situation. For example, in such an operation process, the second object collection may have some permissions to directly perform a change operation on the member objects of the second object collection, for example, the permission to directly perform an adding operation on the member objects of the second object collection. For example, the member object mentioned above may be a user.

For example, in the case that the first object collection is the abovementioned “product-1 team” and the second object collection is the “module-1 communication group” that contains the employees who develop the module 1 under the “product-1 team,” if not all of the employees who develop the product 1 are involved in the development of the module 1 of the product 1, the number of users of the “product-1 team” is greater than the number of users of the “module-1 communication group.” Therefore, when a user is removed from the “product-1 team,” the user in the “module-1 communication group” is also removed accordingly; and when a user is added to the “product-1 team,” it is necessary to determine whether to add the user to the “module-1 communication group” based on whether the user participates in the development of the module 1.

For example, if the second object collection is subordinate to the first object collection and the member objects of the second object collection remain the same as the member objects of the first object collection, the second object collection is set such that all the member objects of the first object collection are allowed to perform information interaction in the second object collection. For example, the member object mentioned above may be a user. Thus, all of the member objects of the first object collection can realize information interaction in the form based on the second object collection.

For example, if the first object collection is the above-described “product-1 team” and the second object collection is the “daily communication group” of the “product-1 team,” users of the “product-1 team” realize information interaction through the “daily communication group.”

For example, in other embodiments of the present disclosure, in the case that the second object collection is subordinate to the first object collection, the second object collection is a sub-collection of the first object collection, and the member objects of the second object collection are different from the member objects of the first object collection, since the first object collection has more member objects than the second object collection, the second object collection is set to allow some of the member objects of the first object collection to perform information interaction in the second object collection.

For example, in the case that the first object collection is the “product-1 team” described above, the second object collection is subordinate to the “module-1 communication group” of the “product-1 team” that contains the employees who develop the module 1, and not all of the employees who develop the product 1 are involved in the development of the module 1, users of the “product-1 team” can also realize information interaction through the “module-1 communication group.”

For example, the first object collection itself may not have the function of realizing information interaction, so that the member objects of the first object collection may not be able to directly perform information interaction in the form based on the first object collection, but need to perform information interaction by means of, for example, the second object collection being subordinate to the first object collection and having an information interaction function.

It should be noted that in some other embodiments of the present disclosure, in the case that the first object collection itself does not have the function of realizing information interaction and the first object collection only has one second object collection subordinate thereto, the first object collection may, for example, not directly provide the information interaction function to the member objects of the first object collection, but the member objects of the first object collection may perform information interaction via the second object collection, so that the first object collection indirectly has the function or effect of providing information interaction. Moreover, the member objects of the second object collection need to remain the same as the member objects of the first object collection, so as to satisfy the need to enable all the member objects of the first object collection to realize information interaction in the form based on the one second object collection.

In some embodiments of the present disclosure, in the case that the second object collection is subordinate to the first object collection, the changing in the above Step S20 includes in response to disbanding the first object collection, removing the association relationship between the first object collection and the second object collection, and maintaining the second object collection.

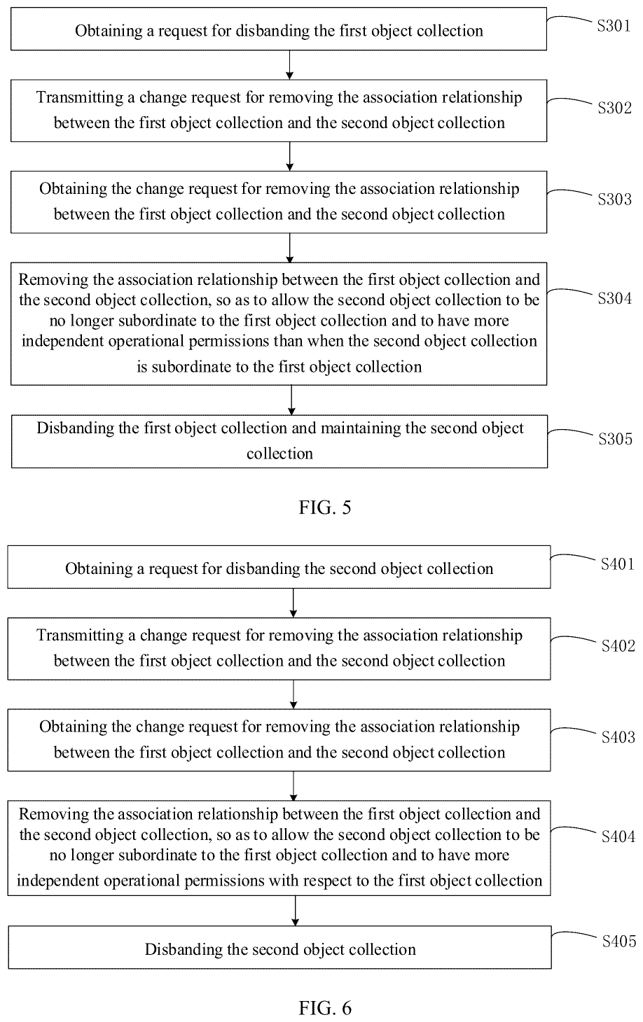

FIG. 5 is a schematic flowchart of a specific example of an interaction method provided by some embodiments of the present disclosure. It should be noted that steps S303 and S304 are respectively substantially the same as or similar to the steps S10 and S20 of the interaction method shown in FIG. 2. Specific descriptions of the steps S303 and S304 may be respectively referred to the related descriptions corresponding to the steps S10 and S20 shown in FIG. 2 in the embodiments of the interaction method described above, and repetitions will be omitted.

As shown in FIG. 5, the interaction method include the following steps S301 to S305.

Step S301: obtaining a request for disbanding the first object collection.

Step S302: transmitting a change request for removing the association relationship between the first object collection and the second object collection.

Step S303: obtaining the change request for removing the association relationship between the first object collection and the second object collection.

Step S304: removing the association relationship between the first object collection and the second object collection, so as to allow the second object collection to be no longer subordinate to the first object collection and to have more independent operational permissions than when the second object collection is subordinate to the first object collection.

Step S305: disbanding the first object collection and maintaining the second object collection.

For example, for the above steps S301 to S305, in the case that the first object collection is disbanded, since the first object collection no longer exists after being disbanded, it is also necessary to remove the association relationship between the first object collection and the second object collection subordinate to the first object collection while disbanding the first object collection. Moreover, the removing of the association relationship does not affect the existence of the second object collection, that is, the removing of the association relationship or the disbandment of the first object collection will not result in the disbandment of the second object collection. Therefore, after the association relationship between the first object collection and the second object collection is removed, the second object collection remains in existence. For example, after the association relationship is removed, the second object collection may exist relatively independently of the first object collection.

Thus, the above interaction method according to the embodiments of the

present disclosure may realize flexible dissolution of the association relationship between the first object collection and the second object collection while maintaining the second object collection, so as to reduce or avoid the possible adverse effects on the data or such as the information interaction function within the second object collection when the association relationship is removed or the first object collection is disbanded.

For example, in the case that the first object collection is the “product-1 team” that contains all the employees who develop the product 1 and the second object collection is the “daily communication group” that is subordinate to the “product-1 team” and contains all the employees who develop the product 1 in the abovementioned application scenario of the online office software, after the association relationship between the “product-1 team” and the “daily communication group” is removed, the “daily communication group” may exist independently of the “product-1 team” and will not be disbanded or deleted. For example, in the case of managing a team scenario and a standalone group scenario in different tabs of the user interface, since the “daily communication group” is no longer subordinate to any team, it will be removed from a tab for managing the team scenario and added to a tab for managing the standalone group scenario, and the user will perform operations on the “daily communication group” in the tab for managing the standalone group scenario.

For example, in the example shown in FIG. 5, the operation of disbanding the first object collection in Step S305 is performed after the Step S304 of removing the association relationship between the first object collection and the second object collection is executed, that is, the first object collection is disbanded after the association relationship between the first object collection and the second object collection is removed. Thus, logical contradictions or instruction errors or the like that may occur during the execution of the steps S301 to S304 may be avoided.

It should be noted that in some other examples of the present disclosure, the operation of disbanding the first object collection in Step S305 may also be executed simultaneously with Step S304, or may also be executed simultaneously with Step S301, Step S302, or Step S303, or may also be executed between any two adjacent steps from the steps S301 to S304. That is, the embodiments of the present disclosure do not impose any limitations on the specific order of execution of the operation of disbanding the first object collection in Step S305.

In some embodiments of the present disclosure, in the case that the second object collection is subordinate to the first object collection, the changing in the above Step S20 includes in response to disbanding the second object collection, removing the association relationship between the first object collection and the second object collection.

FIG. 6 is a schematic flowchart of another specific example of an interaction method provided by some embodiments of the present disclosure. It should be noted that steps S403 and S404 are respectively substantially the same as or similar to the steps S10 and S20 of the interaction method shown in FIG. 2. Specific descriptions of the steps S403 and S404 may be respectively referred to the related descriptions corresponding to the steps S10 and S20 shown in FIG. 2 in the embodiments of the interaction method described above, and repetitions will be omitted.

As shown in FIG. 6, the interaction method includes the following steps S401 to S405. Step S401: obtaining a request for disbanding the second object collection.

Step S402: transmitting a change request for removing the association relationship between the first object collection and the second object collection.

Step S403: obtaining the change request for removing the association relationship between the first object collection and the second object collection.

Step S404: removing the association relationship between the first object collection and the second object collection, so as to allow the second object collection to be no longer subordinate to the first object collection and to have more independent operational permissions with respect to the first object collection.

Step S405: disbanding the second object collection.

For example, for the above steps S401 to S405, in the case that the second object collection is disbanded, since the second object collection no longer exists after being disbanded, it is also necessary to remove the association relationship between the second object collection and the first object collection to which the second object collection is subordinate, while disbanding the second object collection.

For example, after the association relationship between the first object collection and the second object collection is removed, if the first object collection itself is capable of implementing a function or operation such as information interaction, or if all of the member objects of the first object collection are capable of performing a necessary operation required to be satisfied by the first object collection via the other object collection subordinate to the first object collection (e.g., member objects of the other object collection remain the same as the member objects of the first object collection), then the dissolution of the association relationship does not affect the existence of the first object collection. That is, the dissolution of the association relationship or the disbandment of the second object collection will not result in the disbandment of the first object collection. Therefore, in this case, the first object collection remains in existence after the association relationship between the first object collection and the second object collection is removed.

For example, in the case that the first object collection is the “product-1 team” that contains all the employees who develop the product 1 and the second object collection is the “module-1 communication group” that is subordinate to the “product-1 team” and contains all the employees who develop the module 1 of the product 1 in the abovementioned application scenario of the online office software, if not all of the employees involved in the development of the product 1 are involved in the development of the module 1, that is, if the “module-1 communication group” contains only some of the employees involved in the development of the product 1, the “product-1 team” remains in existence and will not be disbanded or deleted after the association relationship between the “product-1 team” and the “module-1 communication group” is removed.

For example, after the association relationship between the first object collection and the second object collection is removed, if the first object collection itself is not capable of implementing a necessary function or operation that is required to be satisfied by the first object collection, for example, information interaction, and the first object collection does not have any other object collection subordinate to it except for the second object collection for which the association relationship has been removed, or all the member objects of the first object collection are not capable of performing the necessary operations required to be performed by the first object collection via other object collections subordinate to the first object collection (e.g., the other object collection has fewer member objects than the first object collection, or the other object collection is not capable of implementing the necessary function or operation required to be performed by the first object collection, such as information interaction), accordingly, in this case, an adaptation or change needs to be made to the first object collection or to other object collections being currently subordinate to the first object collection, so as to satisfy the condition of enabling the continued existence of the first object collection. If it is not possible to satisfy the condition of enabling the continued existence of the first object collection by adapting or changing the first object collection or other object collections being currently subordinate to the first object collection, then the first object collection is disbanded.

For example, in the case that the first object collection is the “product-1 team” that contains all the employees who develop the product 1 and the second object collection is the “daily communication group” (e.g., corresponding to the default communication group of the team) that is subordinate to the “product-1 team” and contains all the employees who develop the product 1 in the abovementioned application scenario of the online office software, if none of the other groups that are subordinate to the “product-1 team” (e.g., the “module-1 communication group” and “module-2 communication group”) contains all of the employees who developed the product 1, users of the “product-1 team” need to be adjusted or changed when the association relationship between the “product-1 team” and the “daily communication group” is removed; otherwise, the “product-1 team” needs to be disbanded or deleted.

Thus, the foregoing interaction method according to the embodiments of the present disclosure may realize flexible dissolution of the association relationship between the first object collection and the second object collection, and may also reduce or avoid the possible adverse effects on the data or the function within the first object collection when the association relationship is removed or the second object collection is disbanded.

For example, in the example shown in FIG. 6, the operation of disbanding the second object collection in Step S405 is performed after Step S404 of removing the association relationship between the first object collection and the second object collection is executed. That is, the second object collection is disbanded after the association relationship between the first object collection and the second object collection is removed. Thus, logical contradictions or instruction errors or the like that may occur during the execution of the steps S401 to S404 can be avoided.

It should be noted that in some other examples of the present disclosure, the operation of disbanding the second object collection in Step S405 may also be executed simultaneously with Step S404, or may also be executed simultaneously with Step S401, Step S402, or Step S403, or may also be executed between any two adjacent steps from the steps S401 to S404. That is, the embodiments of the present disclosure do not impose any limitations on the specific order of execution of the operation of disbanding the second object collection in Step S405.

In some embodiments of the present disclosure, in the case that the second object collection is not subordinate to the first object collection, the changing in the above Step S20 includes establishing the association relationship between the first object collection and the second object collection.

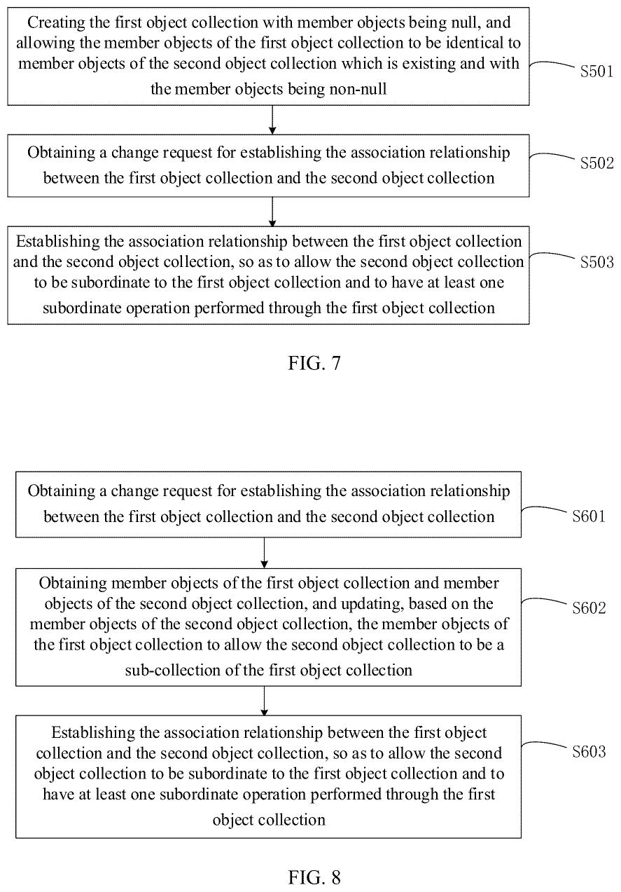

FIG. 7 is a schematic flowchart of further still another specific example of an interaction method provided by some embodiments of the present disclosure. It should be noted that steps S502 and S503 are respectively substantially the same as or similar to the steps S10 and S20 of the interaction method shown in FIG. 2. Specific descriptions of the steps S502 and S503 may be respectively referred to the related descriptions corresponding to the steps S10 and S20 shown in FIG. 2 in the embodiments of the interaction method described above, and repetitions will be omitted.

As shown in FIG. 7, the interaction method includes the following steps S501 to S503.

Step S501: creating the first object collection with member objects being null, and allowing the member objects of the first object collection to be identical to member objects of the second object collection which is existing and with the member objects being non-null.

Step S502: obtaining a change request for establishing the association relationship between the first object collection and the second object collection.

Step S503: establishing the association relationship between the first object collection and the second object collection, so as to allow the second object collection to be subordinate to the first object collection and to have at least one subordinate operation performed through the first object collection.

For example, the member object in Step S501 may be a user.

For example, in Step S501, a new first object collection is created, and member objects of the new first object collection are null initially, that is, the new first object collection does not contain any member objects for the time being. For example, for the above steps S501 to S503, the first object collection may be created by means of the existing second object collection, and by making the member objects of the created first object collection the same as the member objects of the existing second object collection, all the member objects of the first object collection can implement corresponding functions or operations in the form based on the second object collection after the association relationship between the first object collection and the second object collection is established to allow the second object collection to be subordinate to the first object collection.

Furthermore, since the establishment of the association relationship and the creation of the first object collection do not affect the existence of the second object collection itself, that is, the establishment of the association relationship does not result in the disbandment of the second object collection, the second object collection remains in existence but is subordinate to the first object collection after the association relationship between the first object collection and the second object collection is established. Thus, the foregoing interaction method according to the embodiments of the present disclosure may realize flexible creation of the first object collection based on the second object collection and establishment of the association relationship between the first object collection and the second object collection, and may also reduce or avoid the adverse effects such as deletion or loss of data or information within the second object collection.

For example, in the case that the first object collection is the “product-1 team” that contains all the employees who develop the product 1 and the second object collection is the “daily communication group” (e.g., corresponding to the default communication group of the team) that is subordinate to the “product-1 team” and contains all the employees who develop the product 1 in the abovementioned application scenario of the online office software, the “product-1 team” may be created based on the “daily communication group” by the above steps S501 to S503.

For example, in some other examples of the present disclosure, the above Step S501 or creating the first object collection with member objects being null in Step S501 may be performed after Step S502, or may be performed simultaneously with Step S502, and the embodiments of the present disclosure do not impose any specific limitations in this regard.

For example, the above Step S501 may include: obtaining the member objects of the second object collection, and updating, based on the member objects of the second object collection, the member objects of the created first object collection to allow the member objects of the first object collection to be identical to the member objects of the second object collection. Thus, it is possible to allow the second object collection to be a sub-collection of the created first object collection, thus accordingly, after the association relationship is established to allow the second object collection to be subordinate to the first object collection, all the member objects of the first object collection are capable of implementing corresponding functions or operations in the form based on the second object collection.

It should be noted that the embodiments of the present disclosure do not impose specific limitations on the implementation method of the above Step S501 of making the member objects of the first object collection the same as the non-null member objects of the existing second object collection.

In some embodiments of the present disclosure, in the case that the second object collection is not subordinate to the first object collection, the changing in the above Step S20 includes establishing the association relationship between the first object collection and the second object collection, and also the first object collection is not null before Step S10 of obtaining the change request is performed. That is, the changing in the above Step S20 includes establishing the association relationship between the existing first object collection with non-null member objects and the existing second object collection with non-null member objects.

FIG. 8 is a schematic flowchart of further still another specific example of an interaction method provided by some embodiments of the present disclosure. It should be noted that steps S601 and S603 are respectively substantially the same as or similar to the steps S10 and S20 of the interaction method shown in FIG. 2. Specific descriptions of the steps S601 and S603 may be respectively referred to the related descriptions corresponding to the steps S10 and S20 shown in FIG. 2 in the embodiments of the interaction method described above, and repetitions will be omitted.

As shown in FIG. 8, the interaction method includes the following steps S601 to S603.

Step S601: obtaining a change request for establishing the association relationship between the first object collection and the second object collection.

Step S602: obtaining member objects of the first object collection and member objects of the second object collection, and updating, based on the member objects of the second object collection, the member objects of the first object collection to allow the second object collection to be a sub-collection of the first object collection.

Step S603: establishing the association relationship between the first object collection and the second object collection, so as to allow the second object collection to be subordinate to the first object collection and to have at least one subordinate operation performed through the first object collection.

For example, for the above steps S601 to S603, before establishing the association relationship between the existing first object collection with non-null member objects and the existing second object collection with non-null member objects, it is necessary to update the member objects of the first object collection based on the member objects of the second object collection, for example, so that the member objects of the first object collection after the update are the union of the member objects of the second object collection and the member objects of the first object collection before the update, and accordingly the member objects of the second object collection are all included in the member objects of the first object collection. Thus, before the association, there exists in the second object collection any member object A that is not included in the first object collection; and after the association, the member object A needs to be added to the first object collection, thereby enabling the second object collection still to be a sub-collection of the first object collection. Thus, it may contribute to implementing at least part of operations of the member objects of the second object collection through operations (e.g., a member object changing operation) on the member objects of the first object collection. For example, the member object in Step S602 may be a user.

For example, in the case that the first object collection is the “product-1 team” that contains all the employees who develop the product 1 and the second object collection is an existing “technical support group” in the abovementioned application scenario of the online office software, all users in the “technical support group” may be added to the “product-1 team” by performing the above steps S601 to S603, so that the “technical support group” is a sub-collection of the “product-1 team,” and then the association relationship between the “product-1 team” and the “technical support group” is established and the “technical support group” is subordinate to the “product-1 team.” For example, in the case of managing a team scenario and a standalone group scenario in different tabs of the user interface, since the “technical support group” is no longer a standalone group and is now subordinate to the “product-1 team,” the “technical support group” will be removed from the tab for managing the standalone group scenario and added to the tab for managing the team scenario, and located below the “product-1 team” and indented, for example, to the right by a predetermined distance.

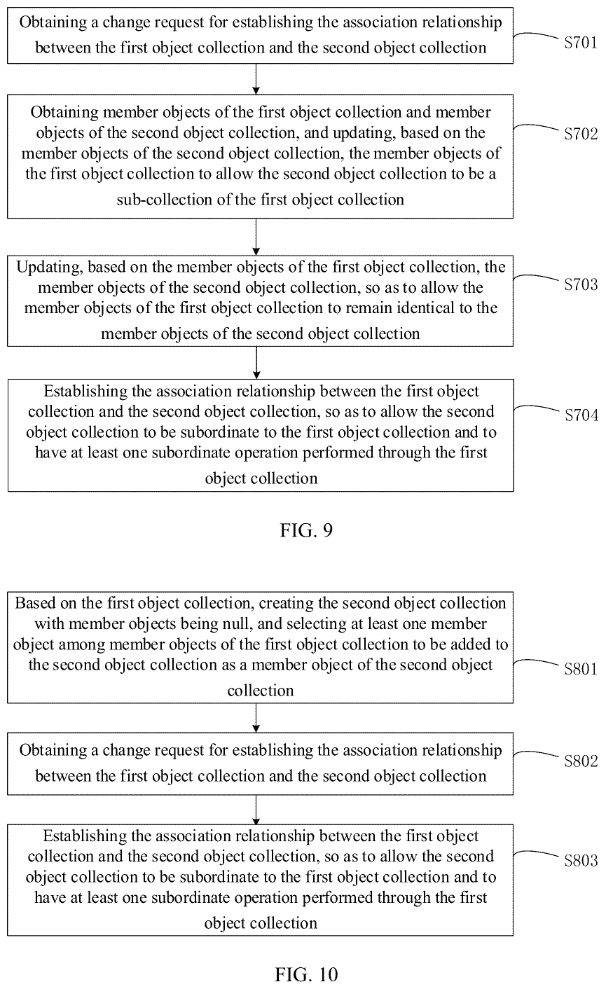

FIG. 9 is a schematic flowchart of further still another specific example of an interaction method provided by some embodiments of the present disclosure. It should be noted that except for Step S703, the other steps S701, S702 and S704 in the interaction method shown in FIG. 9 are substantially the same as or similar to the steps S601 to S603 in the interaction method shown in FIG. 8, respectively, and repetitions will be omitted here. Alternatively, specific descriptions of the steps S701 and S704 may also be referred to the related descriptions corresponding to the steps S10 and S20 shown in FIG. 2 in the embodiments of the interaction method described above, respectively.

As shown in FIG. 9, the interaction method includes the following steps S701 to S704.

Step S701: obtaining a change request for establishing the association relationship between the first object collection and the second object collection.

Step S702: obtaining member objects of the first object collection and member objects of the second object collection, and updating, based on the member objects of the second object collection, the member objects of the first object collection to allow the second object collection to be a sub-collection of the first object collection.

Step S703: updating, based on the member objects of the first object collection, the member objects of the second object collection, so as to allow the member objects of the first object collection to remain identical to the member objects of the second object collection.

Step S704: establishing the association relationship between the first object collection and the second object collection, so as to allow the second object collection to be subordinate to the first object collection and to have at least one subordinate operation performed through the first object collection.

For example, for the above steps S701 to S704, compared to the steps S601 to S603 in the interaction method shown in FIG. 8, before establishing the association relationship between the existing non-null first object collection and the existing non-null second object collection, it is also necessary to update the member objects of the second object collection based on the member objects of the updated first object collection, for example, so that the member objects of the updated second object collection are likewise the union of the member objects of the second object collection before the update and the member objects of the first object collection before the update, and accordingly, the member objects of the first object collection remain the same as the member objects of the second object collection. Thus, before the association, there exists in the second object collection any member object A that is not included in the first object collection and there exists in the first object collection any member object B that is not included in the second object collection; and after the association, the member object A needs to be added to the first object collection, and the member object B needs to be added to the second object collection, so that the second object collection and the first object collection still have the same member objects. Thus, it may contribute to performing corresponding operations on the member objects of the second object collection by performing, for example, an adding operation, a removing operation, or other changing operations on the member objects of the first object collection. For a specific description of some or all of the operations on the member objects of the second object collection that are dependent on the operations on the member objects of the first object collection, reference may be made to the corresponding descriptions above, and repetitions will be omitted.

For example, taking the above “technical support group” and “product-1 team” as an example, after the association relationship between the “product-1 team” and the “technical support group” is established, the above Step S704 can be continued to execute, so as to enable all users of the “product-1 team” to participate in the “technical support group.” FIG. 10 is a schematic flowchart of further still another specific example of an interaction method provided by some embodiments of the present disclosure. It should be noted that steps S802 and S803 are respectively substantially the same as or similar to the steps S10 and S20 of the interaction method shown in FIG. 2. Specific descriptions of the steps S802 and S803 may be respectively referred to the related descriptions corresponding to the steps S10 and S20 shown in FIG. 2 in the embodiments of the interaction method described above, and repetitions will be omitted.

As shown in FIG. 10, the interaction method includes the following steps S801 to S803.

Step S801: based on the first object collection, creating the second object collection with member objects being null, and selecting at least one member object among member objects of the first object collection to be added to the second object collection as a member object of the second object collection.

Step S802: obtaining a change request for establishing the association relationship between the first object collection and the second object collection.

Step S803: establishing the association relationship between the first object collection and the second object collection, so as to allow the second object collection to be subordinate to the first object collection and to have at least one subordinate operation performed through the first object collection.

For example, the member object in Step S801 may be a user.

In Step S801, a new second object collection is created, and member objects of the new second object collection are initially null, that is, the second object collection does not include any member objects for the time being.

For example, for the above steps S801 to S803, the second object collection may be created through the existing first object collection. For example, an operation user selects at least some of the member objects of the first object collection and then adds them to the previously null second object collection. For example, the member objects of the created second object collection may be the same as, or may be fewer than, the member objects of the first object collection, so that the created second object collection is a sub-collection of the first object collection. For example, if it is determined that the member objects of the new second object collection need to be the same as the member objects of the existing first object collection during the creation, all of the member objects of the first object collection may be directly added to the previously null second object collection by the program, without the need for an operation user to intervene. Thus, all of the member objects of the created second object collection are included in the member objects of the first object collection, which contributes to implementing at least part of operations of the member objects of the second object collection through operations (e.g., a member object changing operation) on the member objects of the first object collection after the association relationship is established.

Moreover, since the establishment of the association relationship and the creation of the second object collection do not affect the existence of the first object collection itself, by the interaction method according to the embodiments of the present disclosure, the second object collection may be flexibly created based on the first object collection and the association relationship between the first object collection and the second object collection may be created, that is, the second object collection that is subordinate to the first object collection is created based on the first object collection.

For example, in the case that the first object collection is the “product-1 team” that contains all the employees who develop the product 1 and the second object collection is a new “technical support group” that is created under the “product-1 team” in the abovementioned application scenario of the online office software, the new “technical support group” subordinate to the “product-1 team” may be created by adding all or some of the users in the “product-1 team” to the “technical support group” by performing the above steps S801 to S803. For example, in the case of managing a team scenario and a standalone group scenario separately using different tabs on the user interface, when the “technical support group” is created directly from the “product-1 team,” the operation of creating the “technical support group” is performed while the tab for managing the team scenario is displayed, and the created “technical support group” is displayed directly in the tab for managing the team scenario, and located below the “product-1 team” and, for example, indented to the right by a predetermined distance.

In some embodiments of the present disclosure, the first object collection may be associated with other object collections in addition to having a second object collection subordinate to the first object collection.

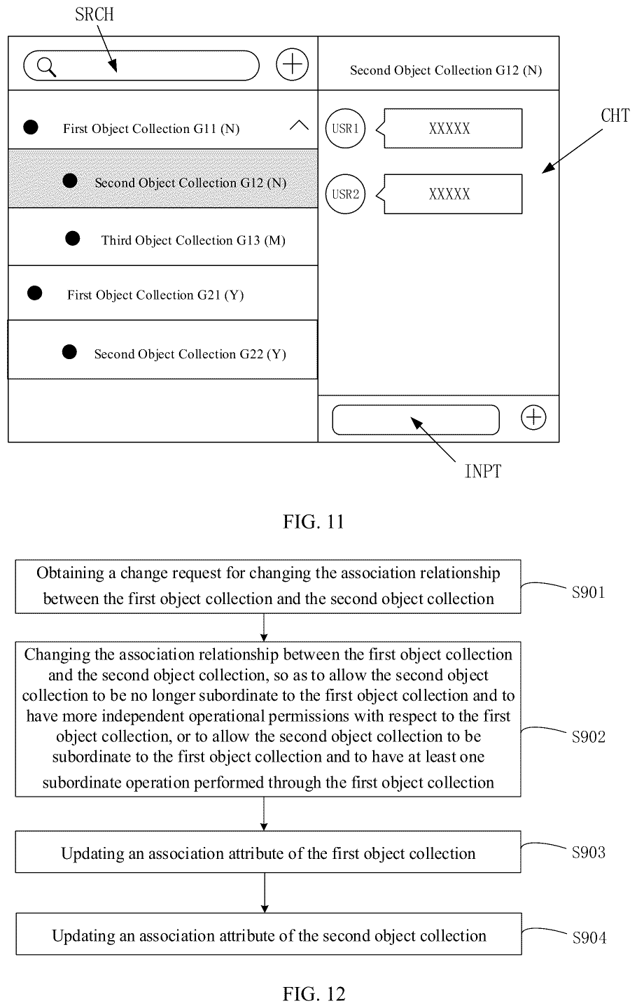

FIG. 11 is a schematic diagram of further still another application example based on a first object collection provided by some embodiments of the present disclosure.

It should be noted that in the example shown in FIG. 11, in addition to the first object collection G11 also having a third object collection G13 subordinate to the first object collection G11, all other contents of the example application are substantially the same as or similar to the example applications shown in FIG. 3 and FIG. 4, and repetitions will be omitted.

For example, in the example shown in FIG. 11, in addition to the second object collection G12 being subordinate to the first object collection G13, the third object collection G13 is also subordinate to the first object collection G11. The third object collection G13 is a sub-collection of the first object collection G11, at least part of operations on the member objects of the third object collection G13 may likewise be dependent on operations on the member objects of the first object collection G11, and the third object collection G13 and the second object collection G12 are not subordinate to each other.

For example, as shown in FIG. 11, M (e.g., M is a positive integer greater than one) member objects of the third object collection G13 may be different types of objects, such as users, a set of users, and the like, or may also be objects used to implement different interaction functions, such as documents, calendars, and teleconferences. For example, in the case that the member objects of the third object collection G13 are users, the third object collection G13 may be a chat group that enables the M member objects of the third object collection G13 to perform instant messaging of information such as text, pictures, voice and video in the third object collection G13, and each member object in the third object collection G13 may realize information interaction in the chat group by sending information such as text, pictures, voice, video, and web links within the chat interface CHT of the chat group. For example, the object types of the member objects of the third object collection G13 may be the same as each other or different from each other. For example, the respective object types of the member objects of the third object collection G13 may be the same as or different from the object type of any of the member objects of the second object collection G12, and the embodiments of the present disclosure do not impose specific limitations on this aspect.

For example, the member objects of the third object collection G13 may be the same as the member objects of the first object collection G11 (i.e., M=N), or may be fewer than the member objects of the first object collection G11 (i.e., M<N).

For example, in the case that the member objects of the third object collection G13 are fewer than the member objects of the first object collection G11, i.e., M<N, when a member object is added to the first object collection G11, the member objects of the third object collection G13 may not be increased accordingly. For example, it is possible that the member objects of the third object collection G13 do not increase with an increase of the member objects of the first object collection G11 when the member objects are set such that the member objects of the third object collection G13 are not allowed to be changed or an adding operation on the member objects of the third object collection G13 is required to satisfy other conditions or to be set separately according to the requirements of the actual application.

For example, in the case that the member objects of the third object collection G13 are the same as the member objects of the first object collection G11, i.e., M=N, an addition or subtraction of a member object in the first object collection G11 may cause the same member object to be added to or subtracted from the third object collection G13, so that the member objects of the third object collection G13 remain the same as those of the first object collection G11.

For descriptions of the operation on the member objects of the third object collection G13 and the change in the association relationship between the third object collection G13 and the first object collection G11, reference may be made to the corresponding contents described above with respect to the second object collection G12, and repetitions will be omitted.

For example, in the case that the member objects of the third object collection G13 are fewer than the member objects of the first object collection G11, when the association relationship between the first object collection G11 and the second object collection G12 is removed, since the first object collection G11 after the association relationship is updated includes only the third object collection G13 and not all member objects of the first object collection G11 can perform information interaction through the third object collection G13, it is therefore necessary to increase the member objects of the third object collection G13 or decrease the member objects of the first object collection G11, so that the member objects of the third object collection G13 remain the same as the member objects of the first object collection G11. If it is not possible to make the member objects of the third object collection G13 the same as the member objects of the first object collection G11 by changing the member objects of the third object collection G13 or the member objects of the first object collection G11, then the first object collection G11 needs to be disbanded due to the fact that the first object collection G11 does not satisfy the condition of allowing all member objects of the first object collection G11 to perform information interaction.

For example, in the case that the member objects of the third object collection G13 remain the same as the member objects of the first object collection G11, when the association relationship between the first object collection G11 and the second object collection G12 is removed, since the first object collection G11 after the association relationship is updated still has the third object collection G13 subordinate to the first object collection G11 and all the member objects of the first object collection G11 can perform information interaction through the third object collection G13, the first object collection G11 may not be disbanded in this case.

For example, in the example shown in FIG. 11, only the case that one third object collection G13 is also subordinate to the first object collection G11 in addition to the second object collection G12 being subordinate to the first object collection G11 is illustrated. It should be noted that in other example applications, the first object collection G11 may also have, for example, two, three, or more third object collections G13 subordinate to the first object collection G11, and the embodiments of the present disclosure do not limit the specific number of third object collections G13 subordinate to the first object collection G11.

For example, in the case that the first object collection G11 has a plurality of third object collections G13 subordinate thereto, the types, attributes, and functions of the plurality of third object collections G13, and the number, types, attributes, functions and the like of member objects therein may be the same as each other or different from each other, and the embodiments of the present disclosure do not impose specific limitations thereto.

FIG. 12 is another schematic flowchart of an interaction method provided by some embodiments of the present disclosure. It should be noted that in addition to steps S903 and S904, other steps S901 and S902 in the interaction method shown in FIG. 12 are respectively substantially the same as or similar to the steps S10 and S20 of the interaction method shown in FIG. 2. Specific descriptions of steps S901 and S902 may also be respectively referred to the related descriptions corresponding to the steps S10 and S20 shown in FIG. 2 in the embodiments of the interaction method described above, and repetitions will be omitted.

As shown in FIG. 12, the interaction method includes the following steps S901 to S904.

Step S901: obtaining a change request for changing the association relationship between the first object collection and the second object collection.

Step S902: changing the association relationship between the first object collection and the second object collection, so as to allow the second object collection to be no longer subordinate to the first object collection and to have more independent operational permissions with respect to the first object collection, or to allow the second object collection to be subordinate to the first object collection and to have at least one subordinate operation performed through the first object collection.

Step S903: updating an association attribute of the first object collection.

Step S904: updating an association attribute of the second object collection.

For example, for the above Step S903, the association attribute of the first object collection includes the association relationship between the first object collection and the second object collection. For example, the association attribute of the first object collection may include whether there is an object collection subordinate to the first object collection, e.g., whether there is a second object collection or a third object collection subordinate to the first object collection, and also include the number of object collections subordinate to the first object collection.

For example, for the above Step S904, the association attribute of the second object collection includes an association state of the second object collection, such as whether the second object collection has an association relationship with any first object collection, or whether the second object collection has been subordinated to any first object collection. Furthermore, in the case that the second object collection has been subordinated to the first object collection, the association attribute of the second object collection further includes a specific association relationship between the first object collection and the second object collection, for example, including the association relationship where the second object collection is subordinate to the first object collection.

For example, in some specific example applications of the present disclosure, as described above, the first object collection may have an association relationship with one or more object collections (e.g., the second object collection or the third object collection), and thus there are one or more other object collections subordinate to the first object collection. Relatively, taking the second object collection as an example, in the case that the second object collection is subordinate to the first object collection, the first object collection has some of operational permissions of the second object collection, that is, part of operations of the second object collection are performed through the first object collection. Therefore, in this case, in order to avoid a confusing and complicated operation flow that may be caused by a plurality of first object collections all having some of operational permissions of the same second object collection, in some embodiments, some of operational permissions of the second object collection belong to only one first object collection. That is, part of operations of the second object collection are carried out through only one first object collection. Thus, in the case that the association state of the second object collection is that it has been subordinate to one first object collection, the second object collection cannot be associated with other first object collections.

For example, in the case that the first object collection is the “product-1 team” that contains all of the employees who develop the product 1, and the second object collection is the existing “technical support group” in the abovementioned application scenario of the online office software, if the “technical support group” has been subordinate to the “product-1 team,” the “technical support group” cannot be associated with any other team, e.g., the “product-2 team,” that is, the “technical support group” can only be bound to one product team.

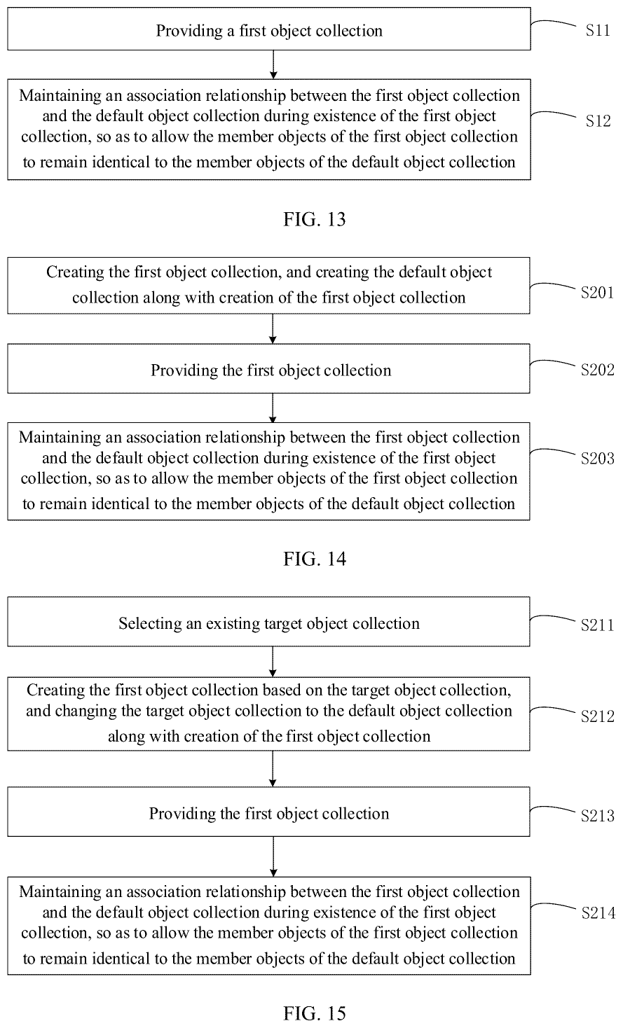

FIG. 13 is further still another schematic flowchart of an interaction method provided by some embodiments of the present disclosure.

As shown in FIG. 13, the interaction method according to the embodiments of the present disclosure includes step S11 and step S12.

Step S11: providing a first object collection. For example, the first object collection has at least one second object collection subordinate to the first object collection, member objects of the first object collection perform interaction in a form based on the at least one second object collection, the at least one second object collection comprises a default object collection, and the member objects of the first object collection are identical to member objects of the default object collection.

Step S12: maintaining an association relationship between the first object collection and the default object collection during existence of the first object collection, so as to allow the member objects of the first object collection to remain identical to the member objects of the default object collection.

For example, for the above steps S11 and S12, by providing the default object collection in the second object collection subordinate to the first object collection, and by remaining the member objects of the first object collection and the member objects of the default object collection the same, the member objects of the first object collection may always perform, for example, information interaction or other desired functions or operations or the like in the form based on the default object collection. Thus, in the case that the default object collection is subordinate to the first object collection, the association relationship between the first object collection and other second object collections (or other object collections that are different from the second object collection) may be established or removed more flexibly while the first object collection remains in existence.

As described above, for example, for the “product-1 team,” the “daily communication group” that contains all the employees who develop the product 1 may be created as the default communication group, the “product-1 team” may further include the “module-1 communication group” that contains the employees who develop the module 1, the “module-2 communication group” that contains the employees who develop the module 2, and the like. The default communication group of the team is bound to the “product-1 team” for information exchange between team members, and when the “product-1 team” is deleted, the default communication group is also deleted.

In some embodiments of the present disclosure, the second object collection is a sub-collection of the first object collection, and some or all of the operations on the member objects of the second object collection depend on the operations on the member objects of the first object collection.

For example, an adding or subtracting operation may be performed on the member objects of the default object collection correspondingly by performing an adding or subtracting operation on the member objects of the first object collection.

For example, the default object collection is set such that no adding or subtracting operation is allowed to be directly performed on the member objects of the default object collection.

The above specific description of the first object collection, the second object collection, and the default object collection may be referred to at least as far as the description of the first object collection and related contents, for example, the member objects of the second object collection remaining the same as the member objects of the first object collection in the embodiments and examples shown in FIG. 2 to FIG. 12 described above, and repetitions will be omitted.

FIG. 14 is further still another schematic flowchart of an interaction method provided by some embodiments of the present disclosure. It should be noted that steps S202 and S203 are respectively substantially the same as or similar to the steps S11 and S12 of the interaction method shown in FIG. 13. Specific descriptions of the steps S202 and S203 may be respectively referred to the related descriptions corresponding to the steps S11 and S12 shown in FIG. 13 in the embodiments of the interaction method described above, and repetitions will be omitted.

As shown in FIG. 14, the interaction method includes the following steps S201 to S203.

Step S201: creating the first object collection, and creating the default object collection along with creation of the first object collection.

Step S202: providing the first object collection. For example, the first object collection has at least one second object collection subordinate to the first object collection, member objects of the first object collection perform interaction in a form based on the at least one second object collection, the at least one second object collection comprises the default object collection, and the member objects of the first object collection are identical to member objects of the default object collection.

Step S203: maintaining an association relationship between the first object collection and the default object collection during existence of the first object collection, so as to allow the member objects of the first object collection to remain identical to the member objects of the default object collection.

For example, for the above steps S201 to S203, the first object collection and the default object collection may be created simultaneously based on the same set of member objects, or they may also be created sequentially based on the same set of member objects. For example, it is possible that after selecting a set of member objects as elements in the collection, the first object collection and the default object collection are created simultaneously based on the same set of member objects, and the association relationship between the first object collection and the default object collection is established after the creation. For example, it is also possible that after selecting the set of member objects as elements in the collection, the default object collection is first created based on the set of member objects, and after that, the first object collection is continued to be created based on the default object collection, and the association relationship between the first object collection and the default object collection is established. For example, it is also possible that after selecting a set of member objects as elements in the collection, the first object collection is first created based on the set of member objects, and after that, the default object collection is created based on the first object collection, and the association relationship between the first object collection and the default object collection is established. The embodiments of the present disclosure do not impose limitations on the specific implementation methods or operation processes for creating the first object collection and the default object collection together described above.

For example, the specific methods or steps described above for first creating the default object collection, then creating the first object collection based on the default object collection, and establishing the association relationship between the first object collection and the default object collection may be referred to the description above corresponding to the embodiments shown in FIG. 7.

FIG. 15 is further still another schematic flowchart of an interaction method provided by some embodiments of the present disclosure. It should be noted that steps S213 and S214 are respectively substantially the same as or similar to the steps S11 and S12 of the interaction method shown in FIG. 13. Specific descriptions of the steps S213 and S214 may be respectively referred to the related descriptions corresponding to the steps S11 and S12 shown in FIG. 13 in the embodiments of the interaction method described above, and repetitions will be omitted.

As shown in FIG. 15, the interaction method includes the following steps S211 to S214.

Step S211: selecting an existing target object collection.

Step S212: creating the first object collection based on the target object collection, and changing the target object collection to the default object collection along with creation of the first object collection.

Step S213: providing the first object collection. For example, the first object collection has at least one second object collection subordinate to the first object collection, member objects of the first object collection perform interaction in a form based on the at least one second object collection, the at least one second object collection comprises the default object collection, and the member objects of the first object collection are identical to member objects of the default object collection.

Step S214: maintaining an association relationship between the first object collection and the default object collection during existence of the first object collection, so as to allow the member objects of the first object collection to remain identical to the member objects of the default object collection.

For example, for the existing target object collection in the above steps S211 and S212, reference may be made to the related description for the existing non-null second object collection corresponding to the embodiments shown in FIG. 7. Specific descriptions of the above steps S211 and S212 may be referred to the related descriptions corresponding to the steps S501 to S503 shown in FIG. 7 described above, and repetitions will be omitted.

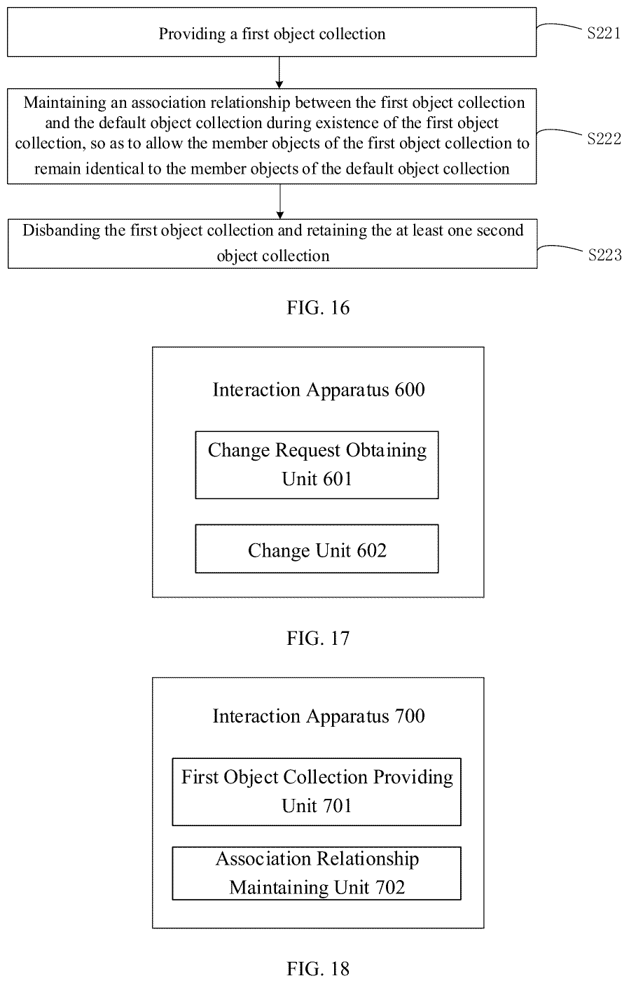

FIG. 16 is further still another schematic flowchart of an interaction method provided by some embodiments of the present disclosure. It should be noted that steps S221 and S222 are respectively substantially the same as or similar to the steps S11 and S12 of the interaction method shown in FIG. 13. Specific descriptions of the steps S221 and S222 may be respectively referred to the related descriptions corresponding to the steps S11 and S12 shown in FIG. 13 in the embodiments of the interaction method described above, and repetitions will be omitted.

As shown in FIG. 16, the interaction method includes the following steps S221 to S223.

Step S221: providing a first object collection. For example, the first object collection has at least one second object collection subordinate to the first object collection, member objects of the first object collection perform interaction in a form based on the at least one second object collection, the at least one second object collection comprises a default object collection, and the member objects of the first object collection are identical to member objects of the default object collection.

Step S222: maintaining an association relationship between the first object collection and the default object collection during existence of the first object collection, so as to allow the member objects of the first object collection to remain identical to the member objects of the default object collection.

Step S223: disbanding the first object collection and retaining the at least one second object collection.

For example, for the specific description of the above Step S223 of disbanding the first object collection and retaining the at least one second object collection, reference may be made to the related descriptions of Step S305 in the corresponding embodiments shown in FIG. 5 described above. For the specific method or operation process of the above Step S223, reference may be made to the above description corresponding to the steps S301 to S305 shown in FIG. 5, and repetitions will be omitted.

In some embodiments of the present disclosure, in response to a change in an association relationship between the first object collection and any one of the at least one second object collection, the interaction method further includes: reminding the member objects of the default object collection by a first prompting mode, so as to allow the member objects of the first object collection to obtain a change prompt in a form based on the default object collection. Thus, with the default object collection provided, in the case of the change in the association relationship between the first object collection and any second object collection, the first prompting mode is used to remind the member object of the default object collection, that is, to remind the member object of the first object collection, so that the member object of the first object collection can keep track of the corresponding changing information.

In some embodiments of the present disclosure, in response to the change in the association relationship between the first object collection and any one of the at least one second object collection, the interaction method further includes reminding member objects of any one of the at least one second object collection by a second prompting mode, and the first prompting mode is different from the second prompting mode.

For example, a reminding intensity of the first prompting mode may be weaker than a reminding intensity of the second prompting mode. For example, if the member objects of the first object collection and the member objects of the second object collection are all users, the first prompting mode may, for example, be a weak prompting mode that only receives notifications but does not actively remind the user, and the second prompting mode may, for example, be a strong prompting mode that actively reminds the user by means of the sound, vibration, pop-up window, or the like. Thus, unnecessary disturbance to the member objects of the first object collection can be weakened or avoided while enabling the member objects of the first object collection to readily learn the corresponding changing information.

It should be noted that, in the embodiments of the present disclosure, the flow of the interaction method provided by the respective embodiments of the present disclosure described above may include more or fewer operations, which may be performed sequentially or in parallel. While the flow of the interaction method described above includes multiple operations occurring in a particular order, it should be clearly understood that there is no limitation on the order of the multiple operations. The interaction method described above may be executed once or multiple times in accordance with predetermined conditions.

At least one embodiment of the present disclosure further provides an interaction apparatus, and the interaction apparatus includes a change request obtaining unit and a change unit; the change request obtaining unit is configured to obtain a change request for changing an association relationship between a first object collection and a second object collection; and the change unit is configured to change the association relationship between the first object collection and the second object collection, so as to allow the second object collection to be no longer subordinate to the first object collection and to allow the second object collection to have more independent operational permissions relative to the first object collection after the changing than before the changing, or to allow the second object collection to be subordinate to the first object collection and to allow at least part of information interaction within the second object collection to be controlled by the first object collection.

The interaction apparatus provided by the above embodiments of the present disclosure can flexibly change an association relationship between the first object collection and the second object collection, and also reduce or avoid possible adverse effects on the data or functions such as information interaction in the first object collection and the second object collection during changing of the association relationship.

FIG. 17 is a schematic block diagram of an interaction apparatus provided by some embodiments of the present disclosure.

For example, as shown in FIG. 17, an interaction apparatus 600 includes a change request obtaining unit 601 and a change unit 602.

The change request obtaining unit 601 is configured to obtain a change request for changing an association relationship between a first object collection and a second object collection. For example, the change request obtaining unit 601 may perform Step S10 in the interaction method shown in FIG. 2.

The change unit 602 is configured to change the association relationship between the first object collection and the second object collection, so as to allow the second object collection to be no longer subordinate to the first object collection and to allow the second object collection to have more independent operational permissions relative to the first object collection after the changing than before the changing, or to allow the second object collection to be subordinate to the first object collection and to allow at least part of information interaction within the second object collection to be controlled by the first object collection. For example, the change unit 602 may perform Step S20 in the interaction method shown in FIG. 2.

For example, the change request obtaining unit 601 and the change unit 602 include codes and programs stored on a memory. A processor may perform the codes and programs to realize some functions or all functions of the change request obtaining unit 601 and the change unit 602 described above. For example, the change request obtaining unit 601 and the change unit 602 may be dedicated hardware devices configured to realize some or all functions of the change request obtaining unit 601 and the change unit 602 described above. For example, the change request obtaining unit 601 and the change unit 602 may be one circuit board or a combination of multiple circuit boards to realize the functions described above. In the embodiments of the present disclosure, the one circuit board or the combination of multiple circuit boards may include: (1) one or more processors; (2) one or more non-transitory memories connected to the processor(s); and (3) firmware which is executable by the processor(s) and stored on the memory.

It should be noted that the specific descriptions of the change request obtaining unit 601 and the change unit 602 may refer to the related descriptions of Step S10 to Step S30 shown in FIG. 2 in the embodiments of the interaction method described above, respectively. Moreover, the interaction apparatus may achieve the technical effects similar to those of the interaction method described above, which will not be described here redundantly.

At least one embodiment of the present disclosure further provides an interaction apparatus, and the interaction apparatus includes a first object collection providing unit and an association relationship maintaining unit; the first object collection providing unit is configured to provide a first object collection, where the first object collection has at least one second object collection subordinate to the first object collection, member objects of the first object collection perform interaction in a form based on the at least one second object collection, the at least one second object collection comprises a default object collection, and the member objects of the first object collection are identical to member objects of the default object collection; and the association relationship maintaining unit is configured to maintain an association relationship between the first object collection and the default object collection during existence of the first object collection, so as to allow the member objects of the first object collection to remain identical to the member objects of the default object collection.

In the interaction apparatus provided by the above embodiments of the present disclosure, a default object collection is provided in the second object collection that is subordinate to the first object collection, and the member objects of the first object collection remain the same as the member objects of the default object collection, so that it can be ensured that all the member objects of the first object collection can implement interaction through the default object collection, and further, in the case of the first object collection having a plurality of second object collections subordinate to the first object collection, some or all of the member objects of the first object collection can implement different forms or types of information interaction through the plurality of second object collections.

FIG. 18 is a schematic block diagram of an interaction apparatus provided by some embodiments of the present disclosure.

For example, as shown in FIG. 18, an interaction apparatus 700 includes a first object collection providing unit 701 and an association relationship maintaining unit 702.

The first object collection providing unit 701 is configured to provide a first object collection, where the first object collection has at least one second object collection subordinate to the first object collection, member objects of the first object collection perform interaction in a form based on the at least one second object collection, the at least one second object collection comprises a default object collection, and the member objects of the first object collection are identical to member objects of the default object collection. For example, the first object collection providing unit 701 may perform Step S11 in the interaction method shown in FIG. 13.

The association relationship maintaining unit 702 is configured to maintain an association relationship between the first object collection and the default object collection during existence of the first object collection, so as to allow the member objects of the first object collection to remain identical to the member objects of the default object collection. For example, the association relationship maintaining unit 702 may perform Step S12 in the interaction method shown in FIG. 13.

For example, the first object collection providing unit 701 and the association relationship maintaining unit 702 include codes and programs stored on a memory. A processor may perform the codes and programs to realize some functions or all functions of the first object collection providing unit 701 and the association relationship maintaining unit 702 described above. For example, the first object collection providing unit 701 and the association relationship maintaining unit 702 may be dedicated hardware devices configured to realize some or all functions of the first object collection providing unit 701 and the association relationship maintaining unit 702 described above. For example, the first object collection providing unit 701 and the association relationship maintaining unit 702 may be one circuit board or a combination of multiple circuit boards to realize the functions described above. In the embodiments of the present disclosure, the one circuit board or the combination of multiple circuit boards may include: (1) one or more processors; (2) one or more non-transitory memories connected to the processor(s); and (3) firmware which is executable by the processor(s) and stored on the memory.

It should be noted that the specific descriptions of the first object collection providing unit 701 and the association relationship maintaining unit 702 may refer to the related descriptions of Step S11 and Step S12 shown in FIG. 13 in the embodiments of the interaction method described above, respectively. Moreover, the interaction apparatus may achieve the technical effects similar to those of the interaction method described above, which will not be described here redundantly.

At least one embodiment of the present disclosure further provides an electronic device. The electronic device includes a processor and a memory. The memory includes one or more computer-executable instructions. The one or more computer-executable instructions are stored on the memory and configured to be executed by the processor. The one or more computer-executable instructions are configured to implement the interaction method provided by any one of the embodiments of the present disclosure.

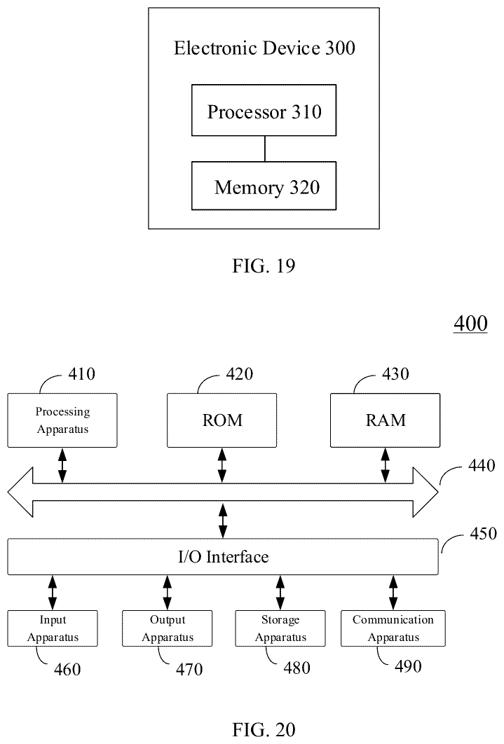

FIG. 19 is a schematic block diagram of an electronic device provided by some embodiments of the present disclosure. As illustrated in FIG. 19, the electronic device 300 includes a processor 310 and a memory 320, which may be configured to implement a client terminal or a server. The memory 320 is configured to store computer-executable instructions (e.g., one or more computer program modules) in a non-transitory manner. The processor 310 is configured to run the computer-executable instructions. The computer-executable instructions, when executed by the processor 310, may implement one or more steps of the interaction method described above, thereby realizing the interaction method described above. The memory 320 and the processor 310 may be interconnected by means of a bus system and/or a connection mechanism in other forms (not shown).

For example, the processor 310 may be a central processing unit (CPU), a graphics processing unit (GPU), or a processing unit in other form having data processing capability and/or program executing capability. For example, the CPU may be an X86 or ARM architecture, or the like. The processor 310 may be a general purpose processor or a special purpose processor, and may control other components in the electronic device 300 to perform desired functions.

For example, the memory 320 may include any combination of one or more computer program products, and the computer program products may include various forms of computer-readable storage media, for example, a volatile memory and/or a non-volatile memory. The volatile memory may include, for example, a random access memory (RAM) and/or a cache, or the like. The non-volatile memory may include, for example, a read only memory (ROM), a hard disk, an erasable programmable read only memory (EPROM), a portable compact disk read only memory (CD-ROM), a USB memory, a flash memory, or the like. One or more computer program modules may be stored on the computer-readable storage medium, and the processor 310 may run the one or more computer program modules, to implement various functions of the electronic device 300. Various applications and various data, as well as various data used and/or generated by the applications may also be stored on the computer-readable storage medium.

It should be noted that, in the embodiments of the present disclosure, the specific functions and technical effects of the electronic device 300 may be with reference to the above description regarding the interaction method, which will not be described here redundantly.

FIG. 20 is a schematic block diagram of another electronic device provided by some embodiments of the present disclosure. The electronic device 400 is, for example, applicable to implementing the interaction method provided by the embodiments of the present disclosure. The electronic device 400 may be a terminal device or the like, and may be configured to implement a client terminal or a server. The electronic device 400 may include but not be limited to mobile terminals, such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device, etc., and fixed terminals, such as a digital TV, a desktop computer, a smart home device, etc. It should be noted that the electronic device 400 shown in FIG. 20 is merely an example and will not impose any limitations on the function and the range of use of the embodiments of the present disclosure.

As illustrated in FIG. 20, the electronic device 400 may include a processing apparatus 410 (e.g., a central processing unit, a graphics processing unit, etc.), which may execute various appropriate actions and processing according to a program stored on a read-only memory (ROM) 420 or a program loaded from a storage apparatus 480 into a random access memory (RAM) 430. The random access memory (RAM) 430 further stores various programs and data required for operation of the electronic device 400. The processing apparatus 410, the ROM 420, and the RAM 430 are connected with each other through a bus 440. An input/output (I/O) interface 450 is also connected to the bus 440.

Usually, apparatuses below may be connected to the I/O interface 450: an input apparatus 460 including, for example, a touch screen, a touch pad, a keyboard, a mouse, a camera, a microphone, an accelerometer, a gyroscope, or the like; an output apparatus 470 including, for example, a liquid crystal display (LCD), a speaker, a vibrator, or the like; a storage apparatus 480 including, for example, a magnetic tape, a hard disk, or the like; and a communication apparatus 490. The communication apparatus 490 may allow the electronic device 400 to perform wireless or wired communication with other electronic devices so as to exchange data. Although FIG. 20 shows the electronic device 400 having various apparatuses, it should be understood that, it is not required to implement or have all the apparatuses illustrated, and the electronic device 400 may alternatively implement or have more or fewer apparatuses.

For example, according to the embodiments of the present disclosure, the interaction method described above may be implemented as computer software programs. For example, the embodiments of the present disclosure include a computer program product, including a computer program carried on a non-transitory computer-readable medium, and the computer program includes program codes for executing the interaction method as described above. In such embodiments, the computer program may be downloaded and installed from the network via the communication apparatus 490, or installed from the storage apparatus 480, or installed from the ROM 420. When executed by the processing apparatus 410, the computer program may implement the functions defined in the interaction method provided by the embodiments of the present disclosure.

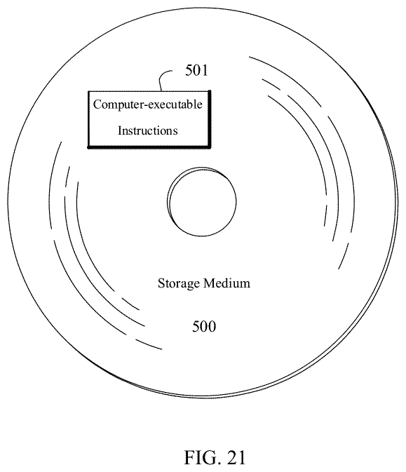

FIG. 21 is a schematic diagram of a storage medium provided by some embodiments of the present disclosure. For example, as illustrated in FIG. 21, the storage medium 500 may be a non-transitory computer-readable storage medium, which is configured to store non-transitory computer-executable instructions 501. When executed by the processor, the non-transitory computer-executable instructions 501 may implement the interaction method according to the embodiments of the present disclosure. For example, when executed by the processor, the non-transitory computer-executable instructions 501 may execute one or more steps of the interaction method described above.

For example, the storage medium 500 may be applied to the above-described electronic device. For example, the storage medium 500 may include a memory in the electronic device.

For example, the storage medium may include a memory card of a smart phone, a storage component of a tablet computer, a hard disk of a personal computer, a random access memory (RAM), a read-only memory (ROM), an erasable programmable read-only memory (EPROM), a portable compact disc read-only memory (CD-ROM), a flash memory, or any combination of the above-described storage media, or other applicable storage media.

For example, the description of the memory in the embodiments of the electronic device may be with reference to illustration of the storage medium 500, and details will not be repeated here. The specific functions and technical effects of the storage medium 500 may be with reference to the above description regarding the interaction method, which will not be described here redundantly.

It should be noted that, in the context of the present disclosure, the computer-readable medium may be a tangible medium that may contain or store programs for use by an instruction execution system, an apparatus, or a device, or for use in combination with an instruction execution system, an apparatus, or a device. The computer-readable medium may be a computer-readable signal medium or a computer-readable storage medium, or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program codes contained on the computer-readable medium may be transmitted by using any suitable medium, including but not limited to an electric wire, a fiber-optic cable, radio frequency (RF) and the like, or any appropriate combination of them.

In some implementations, the client terminal and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-described computer-readable medium may be included in the above-described electronic device, or may also exist alone without being assembled into the electronic device.

The computer program codes for performing the operations of the present disclosure may be written in one or more programming languages or a combination thereof. The above-described programming languages include but are not limited to object-oriented programming languages, such as Java, Smalltalk, C++, and also include conventional procedural programming languages, such as the “C” programming language or similar programming languages. The program codes may by executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flow chart and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units involved in the embodiments of the present disclosure may be implemented in software or hardware. Among them, the name of the unit does not constitute a limitation on the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

According to one or more embodiments of the present disclosure, an interaction method, comprising: obtaining a change request for changing an association relationship between a first object collection and a second object collection; and changing the association relationship between the first object collection and the second object collection, so as to allow the second object collection to be no longer subordinate to the first object collection, or to allow the second object collection to be subordinate to the first object collection.

According to one or more embodiments of the present disclosure, in response to the second object collection no longer being subordinate to the first object collection, the second object collection has more independent operational permissions than when the second object collection is subordinate to the first object collection; or, in response to the second object collection being subordinate to the first object collection, the second object collection has at least one subordinate operation controlled by the first object collection.

According to one or more embodiments of the present disclosure, in response to the second object collection being subordinate to the first object collection, information interaction within the second object collection is at least partially controlled by the first object collection.

According to one or more embodiments of the present disclosure, in response to the second object collection being subordinate to the first object collection, at least part of informational interaction of at least one member object of the first object collection is performed via the second object collection.

According to one or more embodiments of the present disclosure, in response to the second object collection being subordinate to the first object collection, at least one operational permission of the second object collection belongs to the first object collection.

According to one or more embodiments of the present disclosure, obtaining the change request for changing the association relationship between the first object collection and the second object collection comprises: determining, in response to receiving a change triggering operation input by a user, that the change request for changing the association relationship between the first object collection and the second object collection is obtained.

According to one or more embodiments of the present disclosure, in response to the second object collection being subordinate to the first object collection, the second object collection is a sub-collection of the first object collection, and at least one operation on member objects of the second object collection is dependent on an operation on member objects of the first object collection.

According to one or more embodiments of the present disclosure, the at least one operation on the member objects of the second object collection being dependent on the operation on the member objects of the first object collection comprises: performing an adding operation on the member objects of the second object collection correspondingly by performing an adding operation on the member objects of the first object collection, or performing a removing operation on the member objects of the second object collection correspondingly by performing a removing operation on the member objects of the first object collection.

According to one or more embodiments of the present disclosure, the second object collection is configured to be unable to perform the adding operation or the removing operation on the member objects of the second object collection directly.

According to one or more embodiments of the present disclosure, in response to the second object collection being subordinate to the first object collection, member objects of the second object collection remain partially identical to member objects of the first object collection.

According to one or more embodiments of the present disclosure, in response to the second object collection being subordinate to the first object collection, the second object collection is configured to allow at least one member object of the first object collection to perform information interaction through the second object collection.

According to one or more embodiments of the present disclosure, member objects of the second object collection comprise a user or a control for serving the user, and the control is configured to allow the user to perform information interaction through the control.

According to one or more embodiments of the present disclosure, member objects of the first object collection comprise a user, and the first object collection is configured not to directly provide information interaction for the member objects of the first object collection.

According to one or more embodiments of the present disclosure, the information interaction comprises any following operation for a specific member object or an unspecific member object: sending or receiving text information; sending or receiving voice information; sending or receiving video information; sending or receiving picture information; or sending or receiving web link information.

According to one or more embodiments of the present disclosure, at least one third object collection is subordinate to the first object collection, and the at least one third object collection and the second object collection are not subordinate to each other either before or after changing the association relationship between the first object collection and the second object collection.

According to one or more embodiments of the present disclosure, the at least one third object collection is a sub-collection of the first object collection, and at least one operation on member objects of the at least one third object collection is dependent on an operation on member objects of the first object collection.

According to one or more embodiments of the present disclosure, in response to adding one member object to the first object collection, number of member objects of the at least one third object collection is not correspondingly increased.

According to one or more embodiments of the present disclosure, in response to the second object collection being subordinate to the first object collection and the at least one third object collection being subordinate to the first object collection, when one member object is added to or removed from the first object collection, the one member object is accordingly added to or removed from the second object collection and the at least one third object collection.

According to one or more embodiments of the present disclosure, changing the association relationship between the first object collection and the second object collection comprises removing the association relationship between the first object collection and the second object collection, to allow the second object collection to be no longer subordinate to the first object collection and maintain the first object collection and the second object collection respectively.

According to one or more embodiments of the present disclosure, changing the association relationship between the first object collection and the second object collection comprises: in response to disbanding the first object collection, removing the association relationship between the first object collection and the second object collection and maintaining the second object collection.

According to one or more embodiments of the present disclosure, the first object collection is disbanded after the association relationship between the first object collection and the second object collection is removed.

According to one or more embodiments of the present disclosure, changing the association relationship between the first object collection and the second object collection comprises: in response to disbanding the second object collection, removing the association relationship between the first object collection and the second object collection.

According to one or more embodiments of the present disclosure, changing the association relationship between the first object collection and the second object collection comprises: establishing the association relationship between the first object collection and the second object collection, and the interaction method further comprises: creating the first object collection with member objects being null, and allowing the member objects of the first object collection to be identical to member objects of the second object collection which is existing and with the member objects being non-null.

According to one or more embodiments of the present disclosure, allowing the member objects of the first object collection to be identical to the member objects of the second object collection comprises: obtaining the member objects of the second object collection, and updating, based on the member objects of the second object collection, the member objects of the created first object collection to allow the member objects of the first object collection to be identical to the member objects of the second object collection.

According to one or more embodiments of the present disclosure, changing the association relationship between the first object collection and the second object collection comprises: establishing the association relationship between the first object collection and the second object collection, member objects of the first object collection not being null before obtaining the change request; and the interaction method further comprises: obtaining the member objects of the first object collection and member objects of the second object collection, and updating, based on the member objects of the second object collection, the member objects of the first object collection to allow the second object collection to be a sub-collection of the first object collection.

According to one or more embodiments of the present disclosure, the interaction method further comprises: updating, based on the member objects of the first object collection, the member objects of the second object collection to allow the member objects of the first object collection to remain identical to the member objects of the second object collection.

According to one or more embodiments of the present disclosure, before changing the association relationship between the first object collection and the second object collection, the interaction method further comprises: based on the first object collection, creating the second object collection with member objects being null, and selecting at least one member object among member objects of the first object collection to be added to the second object collection as a member object of the second object collection.

According to one or more embodiments of the present disclosure, after changing the association relationship between the first object collection and the second object collection, the interaction method further comprises: updating an association attribute of the first object collection, wherein the association attribute of the first object collection comprises the association relationship between the first object collection and the second object collection; and updating an association attribute of the second object collection, wherein the association attribute of the second object collection comprises an association state of the second object collection, and in response to the second object collection being subordinate to the first object collection, the association attribute of the second object collection further comprises the association relationship between the first object collection and the second object collection.

According to one or more embodiments of the present disclosure, the second object collection being subordinate to the first object collection is presented in a visualization manner.

According to one or more embodiments of the present disclosure, member objects of the first object collection comprise a user, and member objects of the second object collection comprise a user.

According to one or more embodiments of the present disclosure, an interaction method, comprising: providing a first object collection, wherein the first object collection has at least one second object collection subordinate to the first object collection, member objects of the first object collection perform interaction in a form based on the at least one second object collection, the at least one second object collection comprises a default object collection, and the member objects of the first object collection are identical to member objects of the default object collection; and maintaining an association relationship between the first object collection and the default object collection during existence of the first object collection, so as to allow the member objects of the first object collection to remain identical to the member objects of the default object collection.

According to one or more embodiments of the present disclosure, the interaction method further comprises: creating the first object collection, and creating the default object collection along with creation of the first object collection.

According to one or more embodiments of the present disclosure, the interaction method further comprises: selecting an existing target object collection; and creating the first object collection based on the target object collection, and changing the target object collection to the default object collection along with creation of the first object collection.

According to one or more embodiments of the present disclosure, the interaction method further comprises: disbanding the first object collection and retaining the at least one second object collection.

According to one or more embodiments of the present disclosure, the interaction method further comprises: in response to a change in an association relationship between the first object collection and any one of the at least one second object collection, reminding the member objects of the default object collection by a first prompting mode, so as to allow the member objects of the first object collection to obtain a change prompt in a form based on the default object collection.

According to one or more embodiments of the present disclosure, the interaction method further comprises: in response to the change in the association relationship between the first object collection and any one of the at least one second object collection, reminding member objects of any one of the at least one second object collection by a second prompting mode, wherein the first prompting mode is different from the second prompting mode.

According to one or more embodiments of the present disclosure, a reminding intensity of the first prompting mode is weaker than a reminding intensity of the second prompting mode.

According to one or more embodiments of the present disclosure, the at least one second object collection is a sub-collection of the first object collection, and at least one operation on member objects of the at least one second object collection depends on an operation on the member objects of the first object collection.

According to one or more embodiments of the present disclosure, the at least one operation on the member objects of the at least one second object collection depending on the operation on the member objects of the first object collection comprises: performing an adding or removing operation on the member objects of the default object collection correspondingly by performing an adding or removing operation on the member objects of the first object collection.

According to one or more embodiments of the present disclosure, the default object collection is configured to be unable to perform the adding or removing operation on the member objects of the default object collection directly.

According to one or more embodiments of the present disclosure, the member objects of the first object collection comprise a user, and member objects of the second object collection comprise a user.

According to one or more embodiments of the present disclosure, an interaction apparatus, comprising: a change request obtaining unit, configured to obtain a change request for changing an association relationship between a first object collection and a second object collection; and a change unit, configured to change the association relationship between the first object collection and the second object collection, so as to allow the second object collection to be no longer subordinate to the first object collection, or to allow the second object collection to be subordinate to the first object collection.

According to one or more embodiments of the present disclosure, an interaction apparatus, comprising: a first object collection providing unit, configured to provide a first object collection, wherein the first object collection has at least one second object collection subordinate to the first object collection, member objects of the first object collection perform interaction in a form based on the at least one second object collection, the at least one second object collection comprises a default object collection, and the member objects of the first object collection are identical to member objects of the default object collection; and an association relationship maintaining unit, configured to maintain an association relationship between the first object collection and the default object collection during existence of the first object collection, so as to allow the member objects of the first object collection to remain identical to the member objects of the default object collection.

According to one or more embodiments of the present disclosure, an electronic device, comprising: a processor; and a memory, comprising one or more computer-executable instructions, wherein the one or more computer-executable instructions are stored on the memory and configured to be executed by the processor, and the one or more computer-executable instructions are configured to implement the interaction method according to any one of the embodiments of the present disclosure.

According to one or more embodiments of the present disclosure, a storage medium, configured to store non-transitory computer-executable instructions, wherein the non-transitory computer-executable instructions, when executed by a processor, cause the processor to implement the interaction method according to any one of the embodiments of the present disclosure.

The foregoing are merely descriptions of the preferred embodiments of the present disclosure and the explanations of the technical principles involved. It should be understood by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the scope of the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method actions, it should be understood that the subject matter defined in the appended claims is not necessarily limited to the particular features and actions described above. Rather, the particular features and actions described above are merely exemplary forms for implementing the claims.

For the present disclosure, the following statements should be noted.

(1) The accompanying drawings related to the embodiment(s) of the present disclosure involve only the structure(s) in connection with the embodiment(s) of the present disclosure, and other structure(s) can be referred to common design(s).

(2) In case of no conflict, the embodiments of the present disclosure and features in one embodiment or in different embodiments can be combined to obtain new embodiments.

What have been described above merely are specific implementations of the present disclosure, and the protection scope of the present disclosure is not limited thereto. Therefore, the protection scope of the present disclosure should be based on the protection scope of the claims.

1. An interaction method, comprising:
obtaining a change request for changing an association relationship between a first object collection and a second object collection; and
changing the association relationship between the first object collection and the second object collection, so as to allow the second object collection to be no longer subordinate to the first object collection, or to allow the second object collection to be subordinate to the first object collection.

2. The interaction method according to claim 1, wherein in response to the second object collection no longer being subordinate to the first object collection, the second object collection has more independent operational permissions than when the second object collection is subordinate to the first object collection; or,
in response to the second object collection being subordinate to the first object collection, the second object collection has at least one subordinate operation controlled by the first object collection.

3. The interaction method according to claim 1, wherein in response to the second object collection being subordinate to the first object collection, information interaction within the second object collection is at least partially controlled by the first object collection.

4. The interaction method according to claim 1, wherein in response to the second object collection being subordinate to the first object collection, at least part of informational interaction of at least one member object of the first object collection is performed via the second object collection.

5. The interaction method according to claim 1, wherein in response to the second object collection being subordinate to the first object collection, at least one operational permission of the second object collection belongs to the first object collection.

6. The interaction method according to claim 1, wherein obtaining the change request for changing the association relationship between the first object collection and the second object collection comprises:
determining, in response to receiving a change triggering operation input by a user, that the change request for changing the association relationship between the first object collection and the second object collection is obtained.

7. The interaction method according to claim 1, wherein in response to the second object collection being subordinate to the first object collection, the second object collection is a sub-collection of the first object collection, and at least one operation on member objects of the second object collection is dependent on an operation on member objects of the first object collection.

8. The interaction method according to claim 7, wherein the at least one operation on the member objects of the second object collection being dependent on the operation on the member objects of the first object collection comprises at least one of:
performing an adding operation on the member objects of the second object collection correspondingly by performing an adding operation on the member objects of the first object collection, or
performing a removing operation on the member objects of the second object collection correspondingly by performing a removing operation on the member objects of the first object collection, or
allowing the second object collection to be configured unable to perform the adding operation or the removing operation on the member objects of the second object collection directly.

9. (canceled)

10. The interaction method according to claim 1, wherein in response to the second object collection being subordinate to the first object collection, at least one as follows is applied:
member objects of the second object collection remain partially identical to member objects of the first object collection, or
the second object collection is configured to allow at least one member object of the first object collection to perform information interaction through the second object collection.

11. (canceled)

12. The interaction method according to claim 10, wherein at least one as follows is applied:
member objects of the first object collection comprise a user, and member objects of the second object collection comprise a user, or
member objects of the second object collection comprise a user or a control for serving the user, and the control is configured to allow the user to perform information interaction through the control, or
member objects of the first object collection comprise a user, and the first object collection is configured not to directly provide information interaction for the member objects of the first object collection, or
the information interaction comprises any following operation for a specific member object or an unspecific member object:
sending or receiving text information;
sending or receiving voice information;
sending or receiving video information;
sending or receiving picture information; or sending or receiving web link information.

13-14. (canceled)

15. The interaction method according to claim 1, wherein at least one third object collection is subordinate to the first object collection, and the at least one third object collection and the second object collection are not subordinate to each other either before or after changing the association relationship between the first object collection and the second object collection.

16. The interaction method according to claim 15, wherein the at least one third object collection is a sub-collection of the first object collection, and at least one operation on member objects of the at least one third object collection is dependent on an operation on member objects of the first object collection.

17. The interaction method according to claim 15, wherein at least one as follows is applied:
in response to adding one member object to the first object collection, number of member objects of the at least one third object collection is not correspondingly increased, or
in response to the second object collection being subordinate to the first object collection and the at least one third object collection being subordinate to the first object collection, when one member object is added to or removed from the first object collection, the one member object is accordingly added to or removed from the second object collection and the at least one third object collection.

18. (canceled)

19. The interaction method according to claim 1, wherein changing the association relationship between the first object collection and the second object collection comprises at least one of:
removing the association relationship between the first object collection and the second object collection, to allow the second object collection to be no longer subordinate to the first object collection and maintain the first object collection and the second object collection respectively, or
in response to disbanding the first object collection, removing the association relationship between the first object collection and the second object collection and maintaining the second object collection, or
in response to disbanding the second object collection, removing the association relationship between the first object collection and the second object collection, or establishing the association relationship between the first object collection and the second object collection, or
establishing the association relationship between the first object collection and the second object collection, member objects of the first object collection not being null before obtaining the change request.

20. (canceled)

21. The interaction method according to claim 19, wherein at least one as follows is applied:
the first object collection is disbanded after the association relationship between the first object collection and the second object collection is removed, or
the interaction method further comprises: creating the first object collection with member objects being null, and allowing the member objects of the first object collection to be identical to member objects of the second object collection which is existing and with the member objects being non-null, wherein allowing the member objects of the first object collection to be identical to the member objects of the second object collection comprises: obtaining the member objects of the second object collection, and updating, based on the member objects of the second object collection, the member objects of the created first object collection to allow the member objects of the first object collection to be identical to the member objects of the second object collection, or
the interaction method further comprises: obtaining the member objects of the first object collection and member objects of the second object collection, and updating, based on the member objects of the second object collection, the member objects of the first object collection to allow the second object collection to be a sub-collection of the first object collection, or
the interaction method further comprises: updating, based on the member objects of the first object collection, the member objects of the second object collection to allow the member objects of the first object collection to remain identical to the member objects of the second object collection, or
before changing the association relationship between the first object collection and the second object collection, the interaction method further comprises: based on the first object collection, creating the second object collection with member objects being null, and selecting at least one member object among member objects of the first object collection to be added to the second object collection as a member object of the second object collection.

22-27. (canceled)

28. The interaction method according to claim 1, wherein after changing the association relationship between the first object collection and the second object collection, the interaction method further comprises:
updating an association attribute of the first object collection, wherein the association attribute of the first object collection comprises the association relationship between the first object collection and the second object collection; and
updating an association attribute of the second object collection, wherein the association attribute of the second object collection comprises an association state of the second object collection, and in response to the second object collection being subordinate to the first object collection, the association attribute of the second object collection further comprises the association relationship between the first object collection and the second object collection.

29. The interaction method according to claim 1, wherein the second object collection being subordinate to the first object collection is presented in a visualization manner.

30. (canceled)

31. An interaction method, comprising:
providing a first object collection, wherein the first object collection has at least one second object collection subordinate to the first object collection, member objects of the first object collection perform interaction in a form based on the at least one second object collection, and one of the at least one second object collection is configured to be a default object collection for the first object collection; and
maintaining an association relationship between the first object collection and the default object collection during existence of the first object collection.

32. The interaction method according to claim 31, further comprising at least one of:
creating the first object collection, and creating the default object collection along with creation of the first object collection; or
selecting an existing target object collection, and creating the first object collection based on the target object collection, and changing the target object collection to the default object collection along with creation of the first object collection; or
disbanding the first object collection and retaining the at least one second object collection.

33-34. (canceled)

35. The interaction method according to claim 31, further comprising at least one of:
in response to a change in an association relationship between the first object collection and any one of the at least one second object collection, reminding the member objects of the default object collection by a first prompting mode, so as to allow the member objects of the first object collection to obtain a change prompt in a form based on the default object collection; or
in response to the change in the association relationship between the first object collection and any one of the at least one second object collection, reminding member objects of any one of the at least one second object collection by a second prompting mode, wherein the first prompting mode is different from the second prompting mode, wherein a reminding intensity of the first prompting mode is weaker than a reminding intensity of the second prompting mode.

36-37. (canceled)

38. The interaction method according to claim 31, wherein the at least one second object collection is a sub-collection of the first object collection, and at least one operation on member objects of the at least one second object collection depends on an operation on the member objects of the first object collection.

39-41. (canceled)

42. An interaction apparatus, comprising:
a change request obtaining unit, configured to obtain a change request for changing an association relationship between a first object collection and a second object collection; and
a change unit, configured to change the association relationship between the first object collection and the second object collection, so as to allow the second object collection to be no longer subordinate to the first object collection, or to allow the second object collection to be subordinate to the first object collection.

43. An interaction apparatus, comprising:
a first object collection providing unit, configured to provide a first object collection, wherein the first object collection has at least one second object collection subordinate to the first object collection, member objects of the first object collection perform interaction in a form based on the at least one second object collection, and one of the at least one second object collection is configured to be a default object collection for the first object collection; and
an association relationship maintaining unit, configured to maintain an association relationship between the first object collection and the default object collection during existence of the first object collection.

44. An electronic device, comprising:
a processor; and
a memory, comprising one or more computer-executable instructions,
wherein the one or more computer-executable instructions are stored on the memory and configured to be executed by the processor, and the one or more computer-executable instructions are configured to implement the interaction method according to claim 1.

45. A storage medium, configured to store non-transitory computer-executable instructions, wherein the non-transitory computer-executable instructions, when executed by a processor, cause the processor to implement the interaction method according to claim 1.
